(19) United States
(12) Patent Application Publication
(10) Pub. No.: US 2005/0007953 A1
(43) Pub. Date: Jan. 13, 2005

(54) Resource management device, resource management method and recording medium

(75) Inventors: Masato Hirose, Osaka (JP); Hidekazu Yamasaki, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/849,792

(22) Filed: May 21, 2004

(30) Foreign Application Priority Data
May 22, 2003 (JP) 2003-144776

(51) Int. Cl. H04L 12/26

(52) U.S. Cl. 370/229

(57) ABSTRACT

A resource management device includes an application processor and a media processor. The media processor includes function modules, each of which has a basic function and an extended function, a congestion analysis section, a database section and a system management section. If a congestion is detected in response to a function addition request from the user, the congestion analysis section selects an extended function to be deleted, deletes the selected extended function, and then adds the function being requested. Thus, resources can be assigned preferentially to basic functions while releasing resources allocated for extended functions as necessary, thereby efficiently utilizing the resources.

The present application claims priority under 35 USC §119(a) to Japanese Patent Application No. 2003-144776, which is incorporated herein by reference.

### BACKGROUND OF THE INVENTION

1. Field of the Invention

The present invention relates to a resource management device and a resource management method that allow for simultaneous operation of a plurality of media modules in a media processor performing media processing operations.

2. Description of the Background Art

In a conventional resource management method for managing the resource for media processing operations, the maximum amount of resource to be used in each media processing operation is defined in advance, and the defined maximum amount of resource is alllocated when a media processing operation is performed, thereby ensuring a real-time media processing operation. This method controls resource assignments so that the defined maximum amounts are not exceeded, thereby realizing simultaneous execution of a plurality of media processing operations. Such a technique is disclosed in, for example, Japanese Laid-Open Patent Publication No. 10-289115.

### SUMMARY OF THE INVENTION

Recently, however, the number of types of media to be processed by a single media processor and the need for simultaneous execution of a plurality of media processing operations have been increasing. Therefore, it is increasingly important that when the system is running out of its resources, the resources are optimally assigned among the media processing operations to improve the parallel processing of the media processing operations.

Where a plurality of media processing operations are executed simultaneously, the conventional technique always requires a constant amount of resource for each media processing operation without considering the optimal assignment of the media processor resource. Therefore, some portions of the assinged media processor resource are wasted, thus failing to realize an efficient resource assignment.

It is therefore an object of the present invention to provide a media processing method that allows for simultaneous operation of more media modules than with the conventional technique.

A resource management device of the present invention includes a media processor including: a media module for performing a media processing operation; a congestion analysis section for, if it is determined that a resource congestion will occur as a result of a function addition request being issued, changing a resource asignment by referencing module information and module status information, the module information including function information for the media module and resource information for the media processing function, and the module status information indicating whether or not the media processing function is being active; and a system management section for allocating and releasing resources according to the resource assigment changed by the congestion analysis section.

Thus, in the event of resource congestion, the congestion analysis section deletes a function being active, whereby it is possible to efficiently utilize the resources, and it is possible to perform a plurality of media processing operations simultaneously.

Preferably, the resource management device further includes a database section storing the module information and the module status information.

In one embodiment, the media processing function includes a basic function, which is essential for the media processing operation, and an extended function, which is an additional function; and if it is determined that a resource congestion will occur as a result of a function addition request being issued, the congestion analysis section activates a function for which the addition request has been issued after deleting the extended function being active. Thus, it is possible to assign the resources efficiently and to perform the media processing operation without delay.

In one embodiment, there are a plurality of media modules; the module information includes a media module priority; and the media processor further includes a module determination section for, if it is determined that a resource congestion will occur, preferentially selecting a media module having a lower media module priority as a media module whose function is to be deleted. Thus, for example, the function for which the addition request has been issued can be activated while deleting a function of a media processing operation that is not used frequently, whereby it is possible to efficiently assign the resources, and to reduce the overhead of the process, thereby improving the response speed to a user's request.

In one embodiment, the module information includes a function priority for the extended function; and the media processor further includes a function determination section for, if it is determined that a resource congestion will occur, preferentially selecting an extended function having a lower function property as an extended function to be deleted. Thus, it is possible to re-assign the resources used for an extended function having a low priority to the function for which the addition request has been issued, and to further improve the response speed to a user's request.

In one embodiment, the media processor further includes a response processing section for, if it is determined that a resource congestion will occur, inquiring the media modules as to deletion of a plurality of active extended functions, and deciding to delete at least the extended function of the media module that has returned a response first. Thus, it is possible to improve the response speed to a user's request.

A method of the present invention is a resource management method using a resource management device including a media processor, the media processor including a media module, a congestion analysis section and a system management section, the media module performing a media processing operation including an extended function and a basic function, which is essential for the media processing operation, the method including: a step (a) in which if it is determined that a resource congestion will occur as a result of a function addition request being issued, the congestion analysis section changes a resource assignment by referencing module information and module status information, the module information including function information for the media module and resource information for the media processing function, and the module status information indicating whether or not the media processing function is being active; and a step (b) in which the system management section alloccates and releases resources according to the resource assignment changed by the congestion analysis section in the step (a).

With this method, the congestion analysis section re-assigns the resources in the event of resource congestion, thus efficiently utilizing the resources, whereby it is possible to perform a plurality of media processing operations simultaneously.

In one embodiment, the step (a) includes: a step (a1) in which the congestion analysis section compares an amount of resource required for a function being requested to be added with an amount of resource available; and a step (a2) in which if it is determined in the step (a1) that the amount of resource available is less than the amount of resource required for the function being requested to be added, the congestion analysis section makes an inquiry as to deletion of an active function among the extended functions. Thus, the resources are utilized efficiently.

In one embodiment, there are a plurality of media modules; the module information includes a media module priority; and the media processor further includes a module determination section, the step (a) including: a step (a1) in which the congestion analysis section compares an amount of resource required for a function being requested to be added with an amount of resource available; a step (a3) in which if it is determined in the step (a1) that the amount of resource available is less than the amount of resource required for the function being requested to be added, the module determination section preferentially selects a media module having a lower media module priority as a media module whose function is to be deleted; and a step (a4) in which the congestion analysis section makes an inquiry as to deletion of an active function of the media module selected in the step (a3). Thus, in the event of resource congestion, a module having a low priority is deleted preferentially, whereby it is possible to efficiently assign the resources and to reduce the overhead of the process, thus improving the response speed to a user's request.

In one embodiment, the module information includes a function priority for the extended function; and the media processor further includes a function determination section, the step (a) including: a step (a1) in which the congestion analysis section compares the amount of resource required for a function being requested to be added with an amount of resource available; a step (a5) in which if it is determined in the step (a1) that the amount of resource available is less than the amount of resource required for the function being requested to be added, the function determination section preferentially selects an active extended function having a lower function priority as an extended function to be deleted; and a step (a6) in which the congestion analysis section makes an inquiry as to deletion of the extended function selected in the step (a5). Thus, it is possible to preferentially delete a function having a low priority, whereby it is possible to efficiently utilize the resources while improving the response speed to a user's request.

In one embodiment, the media processor further includes a response processing section, the step (a) including: a step (a1) in which the congestion analysis section compares an amount of resource required for a function being requested to be added with an amount of resource available; a step (a7) in which if it is determined in the step (a1) that the amount of resource available is less than the amount of resource required for the function being requested to be added, the congestion analysis section inquires the media module as to deletion of a plurality of active extended functions; a step (a8) in which the response processing section decides to delete at least the extended function of the media module that has returned a response first after the step (a7); and a step (a9) in which the response processing section sends a cancellation response to a media module responding after the step (a8). Thus, even if there are a plurality of media modules having various response speeds, it is possible to improve the response speed to a user's request.

A recording medium of the present invention is a computer-readable recording medium storing a program for instructing a computer to execute: a step (a) of, if it is determined that a resource congestion will occur as a result of a function addition request being issued, changing a resource assignment by referencing module information and module status information, the module information including function information for the media module and resource information for the media processing function, and the module status information indicating whether or not the media processing function is being active; and a step (b) of allocating and releasing resources according to the resource assignment changed in the step (a).

Thus, it is possible to perform a plurality of media processing operations simultaneously using a computer.

### BRIEF DESCRIPTION OF THE DRAWINGS

FIG. 1 is a block diagram illustrating an exemplary resource management device according to the first embodiment of the present invention.

FIG. 2 is a block diagram illustrating, in greater detail, an application processor and a media processor of the resource management device of the first embodiment.

FIG. 3 is a block diagram illustrating, in greater detail, an application processor and a media processor of the resource management device of the first embodiment.

FIG. 4 illustrates exemplary module information stored in a database section in a resource management method of the first embodiment.

FIG. 5 illustrates exemplary module status information stored in a database section in the media processing method of the first embodiment.

FIG. 6 is a flow chart illustrating the flow of a process to be performed in the event of resource congestion according to the media processing method of the first embodiment.

FIG. 7 shows a CPU resource utilization transition in the resource management device of the first embodiment.

FIG. 8 is a block diagram illustrating an exemplary resource management device according to the second embodiment of the present invention.

FIG. 9 illustrates exemplary module information stored in a database section in a resource management method of the second embodiment.

FIG. 10 illustrates exemplary module status information stored in a database section in the media processing method of the first embodiment.

FIG. 11 is a flow chart illustrating the flow of a process to be performed in the event of resource congestion according to the media processing method of the second embodiment.

FIG. 12A shows a CPU resource utilization transition in the resource management device of the first embodiment, and FIG. 12B shows that in the resource management device of the second embodiment.

FIG. 13 is a block diagram illustrating an exemplary resource management device according to the third embodiment of the present invention.

FIG. 14 illustrates exemplary module information stored in a database section in a resource management method of the third embodiment.

FIG. 15 illustrates exemplary module status information stored in a database section in the media processing method of the third embodiment.

FIG. 16 is a flow chart illustrating the flow of a process to be performed in the event of resource congestion according to the media processing method of the third embodiment.

FIG. 17A shows a memory resource utilization transition in the resource management device of the first embodiment, and FIG. 17B shows that in the resource management device of the third embodiment.

FIG. 18 is a block diagram illustrating an exemplary resource management device according to the fourth embodiment of the present invention.

FIG. 19 is a flow chart illustrating the flow of a process to be performed in the event of resource congestion according to the media processing method of the fourth embodiment.

FIG. 20 shows a sequence of signal exchanges between various blocks in the resource management device of the first embodiment and that in the resource management device of the fourth embodiment in a case where a voice communications start request is issued from the voice communications application.

### DESCRIPTION OF THE PREFERRED EMBODIMENTS

Embodiments of the present invention will now be described in detail with reference to the drawings.

First Embodiment

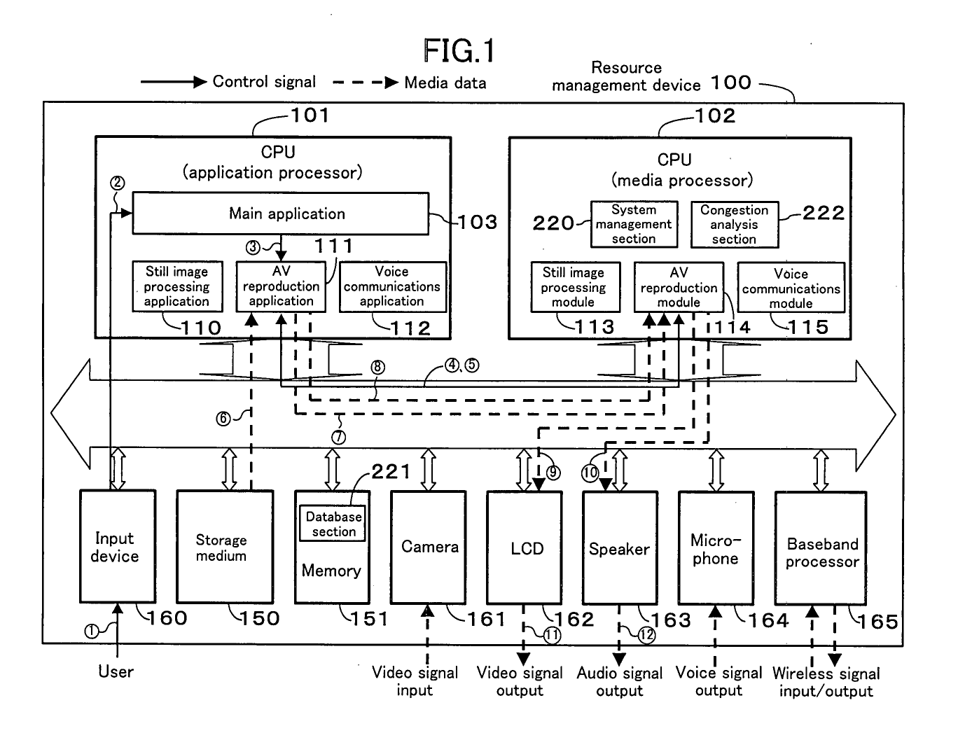

FIG. 1 is a block diagram illustrating an exemplary resource management device according to the first embodiment of the present invention. As illustrated in FIG. 1, a resource management device 100 of the present embodiment includes a CPU (application processor) 101 (hereinafter referred to as the “application processor 101”), a CPU (media processor) 102 (hereinafter referred to as the “media processor 102”), a storage medium 150, a memory 151, an input device 160, a camera 161, an LCD 162, a speaker 163, a microphone 164 and a baseband processor 165.

The application processor 101 includes various applications each for performing a media processing operation by controlling a media module in response to a request from the user. In the present embodiment, the application processor 101 includes a main application 103, a still image processing application 110, an AV play application 111 and a voice communications application 112.

The media processor 102 is a processor that operates at 160 MHz for example, and includes various media modules for performing media processing operations while being controlled by applications. In the present embodiment, the media processor 102 includes a still image processing module 113, an AV play module 114 and a voice communications module 115, as the media modules. The media processor 102 further includes a system management section 220 and a congestion analysis section 222. The system management section 220 and the congestion analysis section 222 are characteristic features of the resource management device of the present embodiment, and will later be described in detail.

While these applications and modules are practically collections of software, they may alternatively be implemented by hardware.

Each media module is assigned a processor resource (hereinafter referred to as a “CPU resource”) necessary for the media processing operation from the media processor 102, whereby the media module can perform the media processing operation. For example, an AV play operation performed by the AV play module 114 requires a CPU resource of up to 52 MHz.

The storage medium 150 is a non-volatile memory for storing media data to be processed by the media modules, e.g., MPEG4 data to be processed by the AV play module 114 in which music/voice data and motion picture data are multiplexed together.

The memory 151 is a non-volatile memory for storing programs of various applications to be run on the application processor 101, programs of various media modules to be run on the media processor 102, and a database section 221. The memory 151 includes a memory area of 512 kB, for example, as a media module execution area. The database section 221 will later be described in detail.

Each media module is assigned a memory area (hereinafter referred to as a “memory resource”) necessary for the media processing operation from the memory 151, whereby the media module can perform the media processing operation. For example, a voice communications operation performed by the voice communications module 115 requires a memory resource of up to 124 KB.

The input device 160 receives an input from the user (Signal (1) in FIG. 1), and sends the content thereof (Signal (2) in FIG. 1) to the main application 103. Then, the main application 103 sends a control signal (Signal (3) in FIG. 1) to each of the still image processing application 110, the AV play application 111 and the voice communications application 112.

The camera 161 receives a video signal of image data, and outputs the image data to the LCD 162 or the still image processing module 113.

The LCD 162 outputs a video signal of image data (Signal (11) in FIG. 1) received from the camera 161 or the AV play module 114. This device can be shared by a plurality of media modules.

The speaker 163 outputs an audio signal of music/voice data (Signal (12) in FIG. 1) received from the AV play module 114 or the voice communications module 115. This device can be shared by a plurality of media modules.

The microphone 164 receives a voice signal of voice data, and outputs the voice data to the voice communications module 115.

The baseband processor 165 is a processor for communicating with other devices using a protocol such as W-CDMA, for example, and outputs the received voice data to the voice communications module 115. The baseband processor 165 also sends voice data received from the voice communications module 115 to other devices.

The main application 103 sends a control signal received from the user via the input device 160 (Signal (2) in FIG. 1) to an appropriate application (Signal (3) in FIG. 1) to control various applications.

The still image processing application 110 receives an instruction from the input device 160 via the main application 103, sends, as a control signal, a still image processing control request, e.g., a still image recording start request or a still image display request, to the still image processing module 113, and receives a response thereto as a control signal.

In response to the instruction (Signal (3) in FIG. 1) transmitted from the input device 160 via the main application 103, the AV play application 111 sends, as a control signal, an AV play control request, e.g., an AV play start request or an image quality adjustment process (e.g., contour enhancement) start request to the AV play module 114, and receives a response thereto as a control signal (Signals (4) and (5) in FIG. 1). Moreover, during the AV play process, the AV play application 111 retrieves stream data, such as MPEG4 stream data, from the storage medium 150 (Signal (6) in FIG. 1), and outputs music/voice data and motion picture data, which are obtained by demultiplexing the stream data, to the AV play module 114 (Signals (7) and (8) in FIG. 1).

In response to a user's instruction received from the input device 160 via the main application 103, the voice communications application 112 sends, as a control signal, a voice communications control request, e.g., a voice communications start request or a volume setting request, to the voice communications module 115, and receives a response thereto as a control signal.

Upon receiving a control signal of the still image recording start request from the still image processing application 110, the still image processing module 113 starts a still image recording operation. The still image processing module 113 encodes still image data from the camera 161 into JPEG data, for example, and outputs the encoded data to the storage medium 150. The still image processing module 113 returns a response control signal each time a request is received from the still image processing application 110.

The AV play module 114 starts an AV play operation by receiving a control signal of an AV play start request from the AV play application 111 (Signal (4) in FIG. 1). The AV play module 114 decodes the music/voice data (Signal (8) in FIG. 1), e.g., AAC (Advanced Audio Coding) data, received from the AV play application 111, and outputs the decoded data to the speaker 163 (Signal (10) in FIG. 1). At the same time, the AV play module 114 decodes the received motion picture data (Signal (7) in FIG. 1), e.g., MPEG4 data, and outputs the decoded data to the LCD 162 (Signal (9) in FIG. 1) in synchronization with the music/voice data. The AV play module 114 returns a response control signal (Signal (5) in FIG. 1) each time a request is received from the AV play application 111.

The voice communications module 115 starts a voice communications operation by receiving a control signal of a voice communications start request from the voice communications application 112. The voice communications module 115 decodes voice data, e.g., AMR (Advanced Multi Rate) data, obtained from the baseband processor 165, and outputs the decoded data to the speaker 163. At the same time, the voice communications module 115 encodes voice data obtained from the microphone 164, and outputs the encoded data to the baseband processor 165, thus realizing a voice communications operation. The voice communications module 115 returns a response control signal each time a request is received from the voice communications application 112.

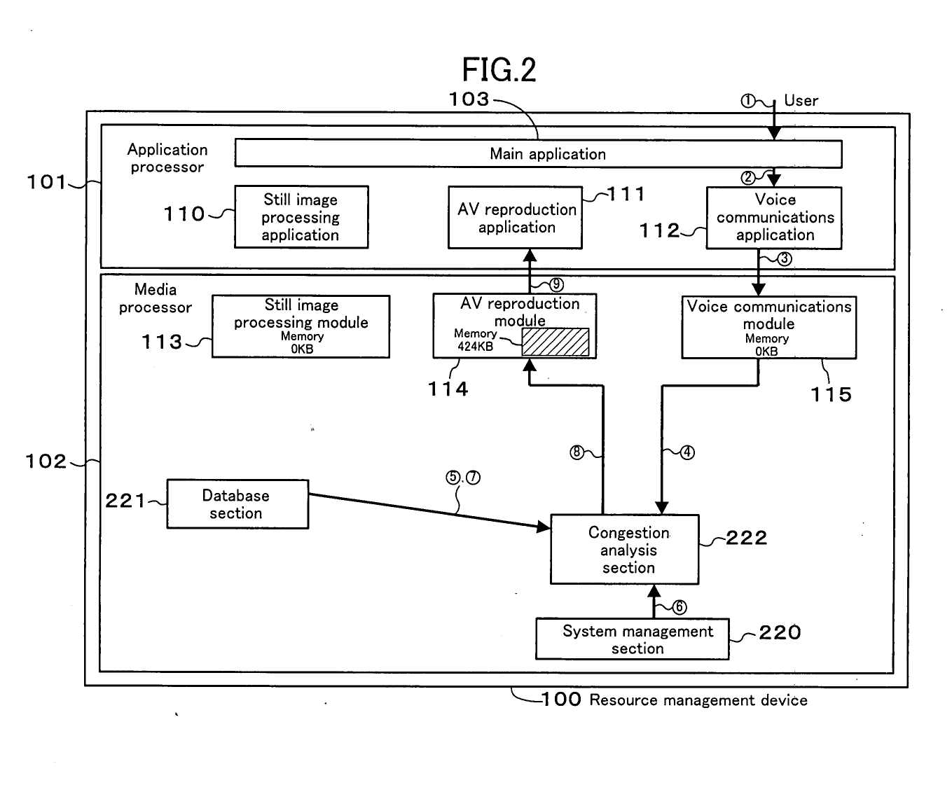

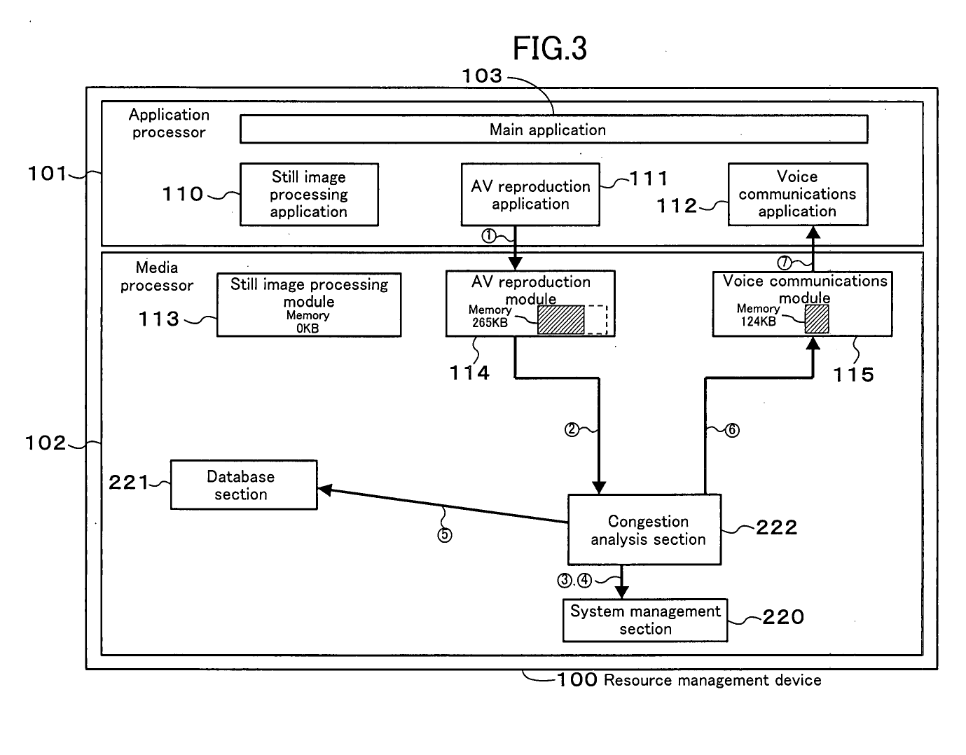

FIG. 2 and FIG. 3 are block diagrams each illustrating, in greater detail, the application processor 101 and the media processor 102 of the resource management device of the present embodiment. The media processor 102 will now be described in greater detail with reference to these figures.

A media module receives a function start request from the user via an application, and sends a function addition request, as a control signal, to the congestion analysis section 222. The media module receives, as a control signal, a response to the function addition request (i.e., a function addition response or a function addition cancellation response) from the congestion analysis section 222. For example, the voice communications module 115 sends a voice communications function addition request (Signal (4) in FIG. 2) to the congestion analysis section 222 according to a voice communications start request (Signal (3) in FIG. 2) from the voice communications application 112. Then, the voice communications module 115 receives a function addition response from the congestion analysis section 222, and sends a voice communications start response to the voice communications application 112.

In the event that the system is running out of its resources (such an event will hereinafter be referred to as “resource congestion”), the media module receives, as a control signal, a function deletion inquiry from the congestion analysis section 222, and sends, as a control signal, a deletion response or a cancellation response in response to the deletion inquiry. As necessary, the media module can transfer, as a control signal, the function deletion process to an application, and receives a response thereto as a control signal, whereby the media module can have the application perform the process. For example, when the AV play module 114 receives, from the congestion analysis section 222, a deletion inquiry for deleting the active motion picture editing function, the AV play module 114 makes a motion picture editing termination inquiry to the AV play application 111. If the AV play module 114 receives, as a response thereto, a motion picture editing termination request (Signal (1) in FIG. 3) from the AV play application 111, the AV play module 114 performs a motion picture editing function termination process and sends a deletion response to the congestion analysis section 222 (Signal (2) in FIG. 3).

The system management section 220 receives, as a control signal, a resource allocation request and a resource release request from the congestion analysis section 222. According to the received request, the system management section 220 allocates and releases various resources being used by the media module (i.e., the CPU resource and the memory resource), and a device or devices being used by the media module (i.e., the camera 161, the LCD 162, the speaker 163, the microphone 164 and the baseband processor 165). Moreover, the system management section 220 calculates the utilization status of each resource, and outputs the calculated status to the congestion analysis section 222 as a control signal.

The database section 221 is provided in the memory 151, as illustrated in FIG. 1, and stores module information for each media module, including function information specifying functions supported by the media module, and resource information specifying the amount of resource required for performing each function.

The function information includes basic function information and extended function information, and the resource information includes the CPU amount, the size of a memory area to be allocated, a list of devices to be used, etc.

Basic functions are primitive functions of a media module, and include one or more minimum functions necessary for the media module. On the other hand, extended functions are those accompanying the basic functions. The voice communications module 115 has the voice communications function as a basic function, and the voice memo recording function and the voice memo reproduction function as extended functions. The AV play module 114 has the AV play function as a basic function, and the motion picture editing function (e.g., combining a motion picture with computer graphics) and the image quality adjustment function (e.g., contour enhancement) as extended functions.

The database section 221 also stores module status information specifying active media modules and functions being used thereby.

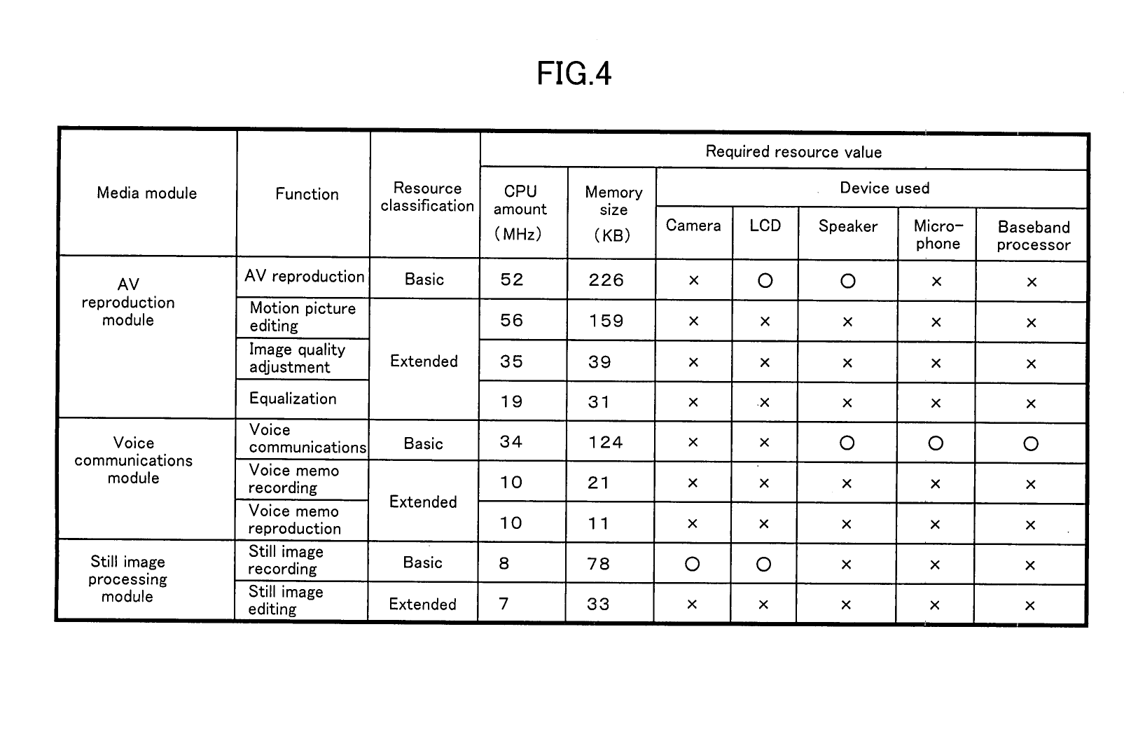

FIG. 4 illustrates exemplary module information stored in the database section 221 in the resource management method of the present embodiment. The module information includes the following items.
(1) Name of media module
(2) Function information
   (i) Function supported by media module
   (ii) Function classification (functions are classified into basic functions and extended functions)
(3) Resource information
   (i) CPU amount (MHz) (i.e., the amount of CPU resource required for the media module to realize the function)
   (ii) Memory size (KB) (i.e., the amount of memory resource required for storing instructions and data that are necessary for the media module to realize the function)
   (iii) Devices to be used (i.e., a device or devices required for the media module to perform the media processing operation; a plurality of devices can be listed; some of the devices can be shared)

In the resource management device of the present embodiment, the database section 221 stores module information for the still image processing module 113, the AV play module 114 and the voice communications module 115. The function information included in the module information of the AV play module 114 specifies the AV play function as a basic function, and the motion picture editing function, the image quality adjustment function and the equalization function as extended functions. The resource information thereof specifies that the AV play function requires a CPU resource of up to 52 MHz, a memory resource of up to 226 KB, the LCD 162 and the speaker 163.

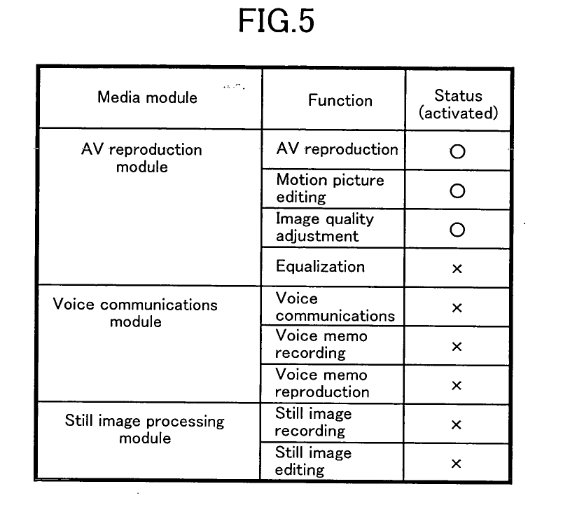

FIG. 5 illustrates exemplary module status information stored in the database section 221 in the media processing method of the present embodiment. The module status information includes the following items.
(1) Name of active media module
(2) Name of active function In the resource management device of the present embodiment, the database section 221 stores module status information for the still image processing module 113, the AV play module 114 and the voice communications module 115. In the example illustrated in FIG. 5, the module status information specifies that the AV play function, the motion picture editing function and the image quality adjustment function of the AV play module 114 have been activated and available.

The congestion analysis section 222 receives, as a control signal, a function addition request from the media module, and retrieves corresponding resource information from the database section 221 using the name of the media module and the name of the function included in the function addition request as search keys, while obtaining the current resource utilization status from the system management section 220, to analyze the resource congestion.

If there is no resource congestion, the congestion analysis section 222 issues a resource allocation request to the system management section 220 to assign an amount of resource to the function being requested to be added, and updates the module status information in the database section 221. Then, the congestion analysis section 222 gives the media module a response to the resource allocation request.

If there is a resource congestion, the congestion analysis section 222 issues a function deletion inquiry to a media module having an extended function that has been selected as the function to be deleted. If the inquiry is responded with a deletion response, the congestion analysis section 222 requests the system management section 220 to release the resource allocated for the function, and then requests an amount of resource to be assigned for the addition of the function being requested. Thus, the congestion analysis section 222 responds to the media module while updating the module status information of the database section 221.

Now, the flow of the process to be performed in the event of resource congestion will be described, according to the media processing method of the present embodiment.

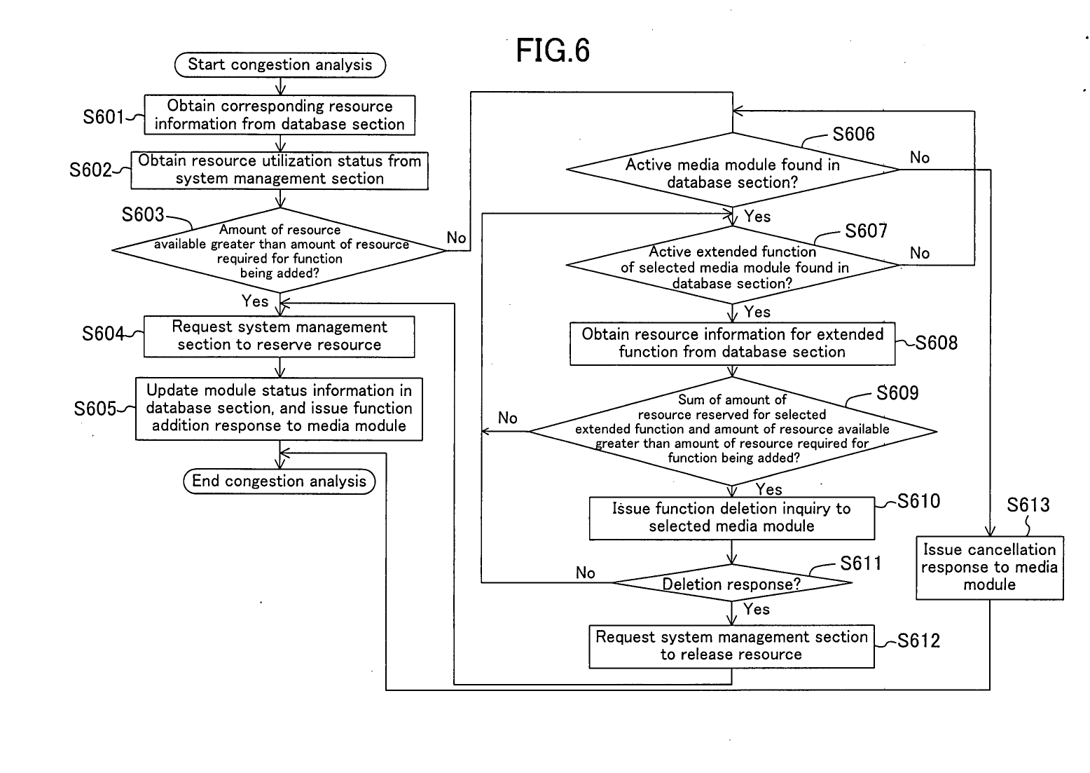

FIG. 6 is a flow chart illustrating the flow of the process to be performed in the event of resource congestion in the media processing method of the present embodiment. The flow of the process including the congestion analysis, the deletion of an extended function and the addition of a requested function will now be described below.

First, in step S601, the congestion analysis section 222 receives a function addition request from a media module, and retrieves the resource information for the function to be added from the module information of the database section 221 using the name of the media module and the name of the extended function included in the function addition request as search keys.

Then, in step S602, the congestion analysis section 222 retrieves the current resource utilization status from the system management section 220. In this step, the resource utilization statuses of the CPU and the memory, and the utilization status of the device are obtained.

Then, in step S603, based on the resource information obtained in steps S601 and S602, the congestion analysis section 222 compares the amount of resource required for the function being requested to be added with the amount of resource available, for each of the CPU, memory and device resources. If it is determined in this step that the amount of resource available exceeds the amount of resource required for the function to be added (i.e., “Yes” in this step), the process proceeds to step S604. If the amount of resource available is not sufficient (i.e., “No” in this step), the process proceeds to step S606.

Then, in step S604, based on the resource information obtained in step S601, the congestion analysis section 222 requests the system management section 220 to allocate a CPU resource, a memory resource and a device resource.

Then, in step S605, the module status information in the database section 221 is updated to register the status of the function added in step S604, and the congestion analysis section 222 sends a function addition response to the media module that has issued the function addition request. Also when an extended function is deleted in step S612 to be described later, the status of the function is registered in the module status information in the database section 221.

If it is determined in step S603 that the amount of resource required for the function being requested to be added cannot be allocated, the congestion analysis section 222 searches for active media modules in order to determine an extended function or functions to be deleted from among the active extended functions. Then, the congestion analysis section 222 searches for active extended functions of the selected media module to detect an extended function that can be deleted. This process can be performed as follows.

First, in step S606, the module status information stored in the database section 221 is searched through starting from the beginning thereof to find an active media module. If an active media module is found (i.e., “Yes” in this step), the process proceeds to step S607. If no active media module can be found from among the records of the module status information (i.e., “No” in this step), it is determined that no extended function that can be deleted is found in the selected media module, and the process proceeds to step S613.

In step S607, the congestion analysis section 222 searches through the records of the module status information corresponding to the media module selected in step S606 starting from the beginning thereof in order to determine one extended function to be deleted from among the active extended functions of the selected media module. If an active extended function is found based on the module status information (i.e., “Yes” in this step), the process proceeds to step S608. If no active extended function can be found from among the records of the module status information (i.e., “No” in this step), it is determined that no extended function that can be deleted is found in the selected media module, and the process proceeds to step S606 to repeat the process.

Then, in step S608, the resource information of the extended function selected in step S607 is obtained from the database section 221.

Then, in step S609, based on the resource information obtained in steps S601, S602 and S608, the congestion analysis section 222 compares the amount of resource required for the function being requested to be added with the sum of the amount of resource allocated by the extended function and the amount of resource available, for each of the CPU, memory and device resources. If the sum of the amount of resource available and the amount of resource allocated by the selected extended function is greater than the amount of resource required for the function being added (i.e., “Yes” in this step), the selected extended function is finally determined as a function to be deleted, and the process proceeds to step S610. If an amount of resource required for the function being added cannot be allocated by deleting only one extended function, two or more extended functions may be deleted. If the amount of resource required for the function being added cannot be allocated by deleting the selected extended function (i.e., “No” in this step), it is determined that the selected extended function is not to be deleted, and the process proceeds to step S607 to repeat the process.

Then, in step S610, the congestion analysis section 222 makes a function deletion inquiry to the media module selected in step S606, and waits for a response thereto.

Then, in step S611, the congestion analysis section 222 makes a determination based on the response to the function deletion inquiry made to the media module in step S610. If the response to the function deletion inquiry is a deletion response (i.e., “Yes” in this step), it is determined that the extended function is to be deleted, and the process proceeds to step S612. If the response is a cancellation response (i.e., “No” in this step), it is determined that the extended function cannot be deleted, and the process proceeds to step S607 to repeat the process.

Then, in step S612, the congestion analysis section 222 requests the system management section 220 to release the CPU, memory and device resources based on the resource information obtained in step S608 in order to delete the extended function to be deleted. Then, the process proceeds to step S604.

If no extended function that can be deleted is found in step S606, the congestion analysis section 222 sends a function addition cancellation response to the media module that has sent the function addition request in step S613. The congestion analysis is performed as described above.

Now, the congestion analysis of the resource management device of the present embodiment will be described with a specific example.

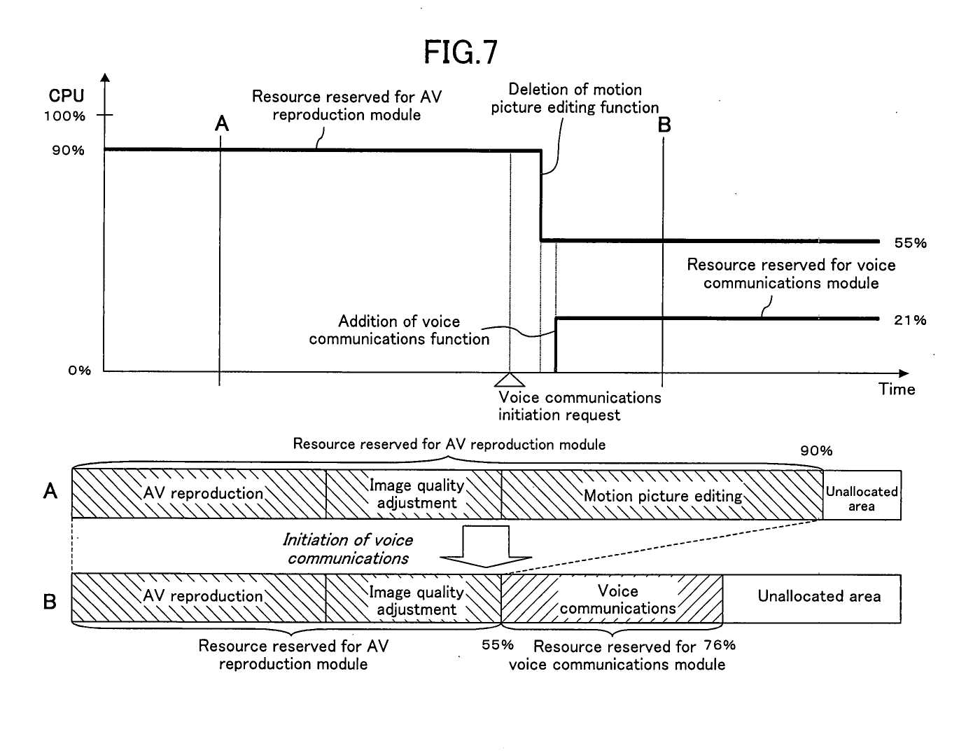

FIG. 7 shows a CPU resource utilization transition in the resource management device of the present embodiment. Particularly, the CPU resource utilizations of the media modules at time A and those at time B are shown in detail in order to illustrate the transition in the CPU resource before and after the addition of the voice communications function.

When the user gives a voice communications request to the voice communications application 112 (Signals (1) and (2) in FIG. 2) while the AV play function, the motion picture editing function and the image quality adjustment function of the AV play module 114 have been activated and available as illustrated in FIG. 5, the voice communications application 112 sends a voice communications start request to the voice communications module 115 (Signal (3) in FIG. 2). Receiving the request, the voice communications module 115 sends a voice communications function addition request to the congestion analysis section 222 (Signal (4) in FIG. 2).

Receiving the voice communications function addition request, the congestion analysis section 222 retrieves the resource information for the voice communications function (indicating that the function requires a CPU amount of 34 MHz (accounting for 21% of the total CPU resource), a memory size of 124 KB, and the speaker 163 and the microphone 164) from the module information in the database section 221 as illustrated in FIG. 4 (Signal (5) in FIG. 2), using the name of the media module and the name of the function (i.e., “voice communications module” and “voice communications function”) included in the request as search keys.

At the same time, the congestion analysis section 222 obtains the resource utilization status from the system management section 220 (Signal (6) in FIG. 2). The resource utilization status indicates that 90% of the CPU resource (160 MHz) is being allocated for the AV play module 114, leaving 10% thereof unassigned, as illustrated in FIG. 7, that 424 KB of the memory resource (512 KB) is being allocated for the AV play module 114, leaving 88 KB unassigned, as illustrated in FIG. 2, and that the LCD 162 and the speaker 163 are being used by the AV play module 114 as illustrated in FIG. 4. As for the CPU resource, 33% (52 MHz) thereof is allocated for the AV play function, 35% (56 MHz) for the motion picture editing function, and 22% (35 MHz) for the image quality adjustment function.

Then, the congestion analysis section 222 compares the amount of resource required for the voice communications function being requested to be added with the amount of resource available, for each of the CPU, memory and device resources. The comparison indicates that only 10% of the CPU resource is available while 21% thereof is being requested. Thus, the congestion analysis section 222 detects a congestion for the CPU resource. Also for the memory resource, only 88 KB is available while 124 KB is being requested, and thus the congestion analysis section 222 detects a congestion. As for the device resource, although the speaker 163 is being used by the AV play module 114, the speaker 163 is a sharable device, whereby no congestion is detected. Thus, based on the congestion detection for the CPU resource and the memory resource, it is determined that a resource congestion will occur.

If a congestion is detected, the congestion analysis section 222 reads out the module information of active media modules starting from the beginning thereof, based on the module status information in the database section 221 as illustrated in FIG. 5. In this process, the congestion analysis section 222 reads out the module information starting from the beginning thereof so as to determine if there is, in the module information, resource information on a resource allocated for an active extended function.

Thus, the congestion analysis section 222 first reads out, from the module information of FIG. 4, the resource information of the motion picture editing function of the AV play module 114 (indicating that the function requires a CPU amount of 56 MHz (accounting for 35% of the total CPU resource) and a memory size of 159 KB) (Signal (7) in FIG. 2).

Then, the congestion analysis section 222 compares the amount of resource required for the voice communications function being requested to be added with the amount of resource that would be available if the resources being alocated for the motion picture editing function were released, for each of the CPU, memory and device resources. As for the CPU resource, there will be a 45% (=35%+10%) resource available for a 21% resource request, whereby a congestion is no longer detected. As for the memory resource, there will be a 247 KB (=159 KB+88 KB) resource available for a 124 KB resource request, whereby a congestion is no longer detected. Thus, it is determined that a resource congestion will not occur without the motion picture editing function, and the motion picture editing function is decided to be deleted.

Then, the congestion analysis section 222 makes an inquiry as to deletion of the motion picture editing function to the AV play module 114 responsible for the motion picture editing function to be deleted (Signal (8) in FIG. 2).

Receiving the deletion inquiry for deleting the motion picture editing function, the AV play module 114 makes a motion picture editing termination inquiry to the AV play application 111 in order to terminate the motion picture editing function (Signal (9) in FIG. 2).

Receiving the motion picture editing termination inquiry, the AV play application 111 sends a motion picture editing termination request to the AV play module 114 in order to terminate the motion picture editing function (Signal (1) in FIG. 3). At this time, the user may be prompted to make a confirmation as to the termination of the motion picture editing function via a GUI, as necessary.

Receiving the motion picture editing termination request, the AV play module 114 performs a motion picture editing termination process, and returns a deletion response to the congestion analysis section 222 (Signal (2) in FIG. 3).

Receiving the deletion response, the congestion analysis section 222 requests the system management section 220 to release the resource based on the previously-obtained resource information for the motion picture editing function, and deletes the motion picture editing function (Signal (3) in FIG. 3). Then, the CPU resource allocated for the AV play module 114 decreases from 90% at time A to 55% at time B, as illustrated in FIG. 7. The memory resource also decreases from 424 KB to 265 KB, as illustrated in FIG. 3.

After the resource is released, the congestion analysis section 222 requests the system management section 220 to allocate a resource based on the previously-obtained resource information for the voice communications function, and adds the voice communications function (Signal (4) in FIG. 3). Then, the CPU resource allocated for the voice communications module 115 increases from 0% at time A to 21% at time B, as illustrated in FIG. 7. The memory resource also increases from 0 KB to 124 KB, as illustrated in FIG. 3. Moreover, the speaker 163 and the microphone 164 become available for the added function.

Then, the congestion analysis section 222 updates the module status information in the database section 221 illustrated in FIG. 5 (Signal (5) in FIG. 3) so as to indicate that the motion picture editing function has been deleted and the voice communications function has been added. In the module status information, the motion picture editing function of the AV play module 114 is updated from “activated” to “deleted”, and the voice communications function of the voice communications module 115 is updated to “activated”. Then, the congestion analysis section 222 returns a function addition response to the voice communications module 115 (Signal (6) in FIG. 3).

Then, receiving the function addition response, the voice communications module 115 returns a voice communications start response to the voice communications application 112 (Signal (7) in FIG. 3).

Through the process described above, the state at time A, when only the AV play module 114 is being active, transitions to the state at time B, when the motion picture editing function of the AV play module 114 has been deleted and the voice communications function has been added in response to the voice communications start request from the voice communications application 112, as illustrated in FIG. 7. Thus, at time B, the AV play module 114 and the voice communications module 115 are operating simultaneously.

Thus, by classifying functions supported by media modules into basic functions and extended functions, resources can be assigned preferentially to basic functions while releasing resources allocated for extended functions as necessary in the event of resource congestion. In other words, when activating a new function, an extended function that is being active but not used can be deleted, thereby efficiently utilizing the resources. Thus, with the media processing method of the present embodiment, a plurality of media processing operations can be performed simultaneously with no problems.

In the present embodiment, an exemplary classification of basic functions and extended functions has been described above in connection with the still image process, the AV play process and the voice communications process. However, the classification of functions is not limited thereto in the present invention. For example, the resources required for reproducing audio files of various formats such as MP3, AAC and WMA in the AV play process can each be classified as an extended function. The types of resources handled by the resource management device are not limited to the CPU resource, the memory resource and the device resource, but may also include other types of resources such as the DMA bandwidth.

While an application processor and a media processor are provided separately in the resource management device of the present embodiment, the media processing method of the present embodiment can also be applied to a case where the application processing operation and the media processing operation are performed by a common processor.

While the database section 221 storing the module information is provided in the media processor 102 in the resource management device of the present embodiment, the database section 221 may alternatively be provided outside the resource management device.

Second Embodiment

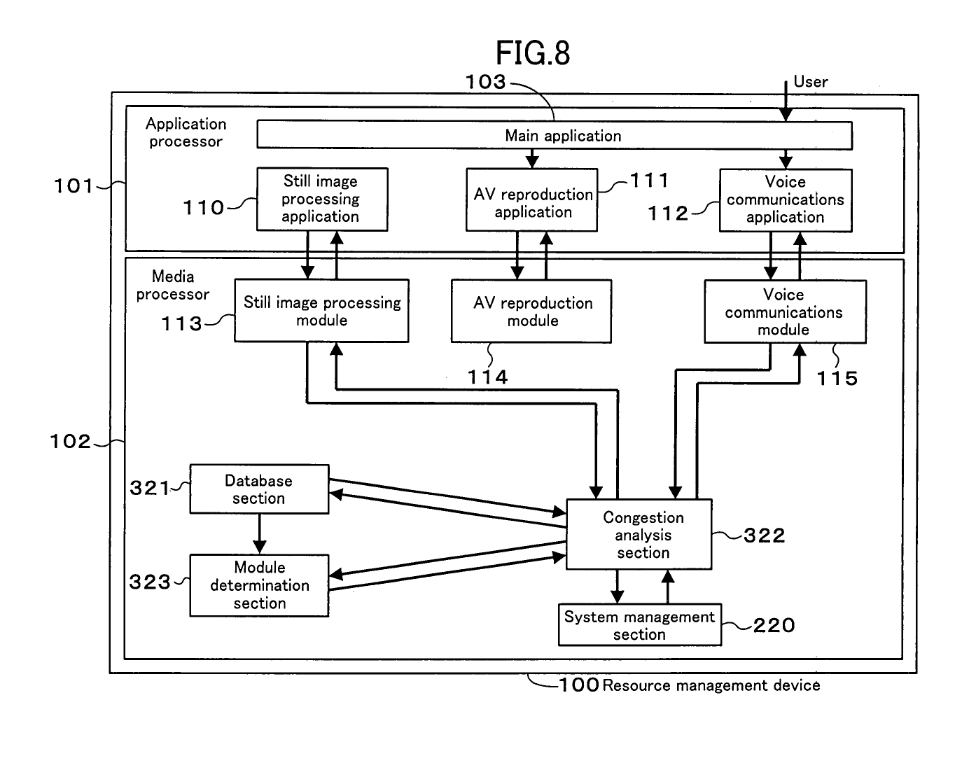

FIG. 8 is a block diagram illustrating an exemplary resource management device according to the second embodiment of the present invention.

The illustrated resource management device 100 of the present embodiment includes the application processor 101 and the media processor 102.

The application processor 101 includes the main application 103, the still image processing application 110, the AV play application 111 and the voice communications application 112.

The media processor 102 includes the still image processing module 113, the AV play module 114, the voice communications module 115, the system management section 220, a congestion analysis section 322, a database section 321 and a module determination section 323.

The resource management device of the present embodiment differs from the resource management device of the first embodiment in that the module determination section 323 is provided in the media processor 102. The database section 321 and the congestion analysis section 322 of the resource management device of the present embodiment correspond respectively to the database section 221 and the congestion analysis section 222 of the resource management device of the first embodiment.

Components added to the resource management device in the present embodiment will now be described.

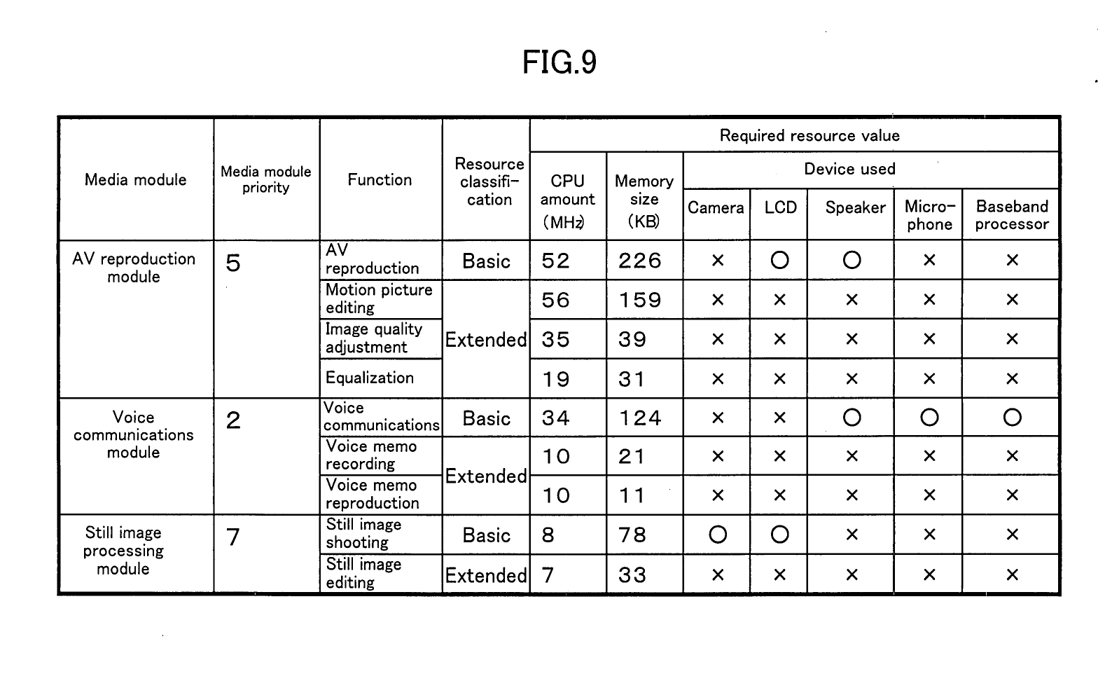

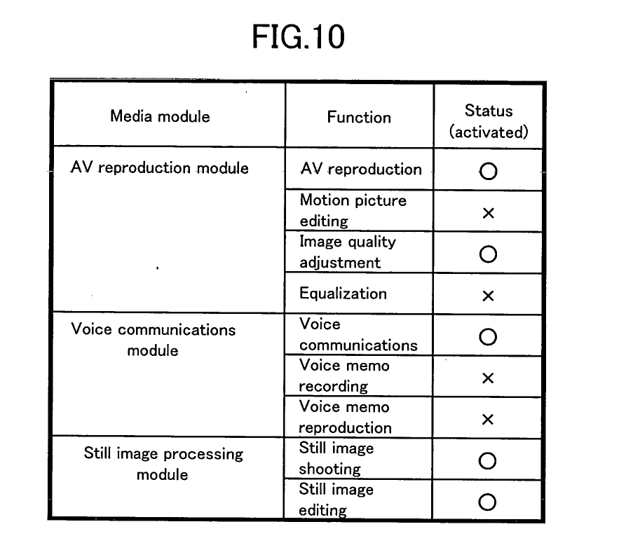

FIG. 9 illustrates exemplary module information stored in the database section 321 in the resource management method of the present embodiment, and FIG. 10 illustrates exemplary module status information stored in the database section 321 in the media processing method of the present embodiment.

The module information illustrated in FIG. 9 and the module status information illustrated in FIG. 10 are both stored in the database section 321. The module information includes the function information and the resource information, as does the module information illustrated in FIG. 4, but the function information thereof further includes the media module priority for each module.

In the event of resource congestion, the media module priority specifies which one of the active extended functions should be deleted. In other words, the media module priority is an indication with which a function to be deleted can be decided. In the first embodiment, in the event of resource congestion, the database is searched through starting from the beginning thereof for an extended function to be deleted, and the extended function found is deleted. In this way, however, the deleted extended function may be called for soon after the deletion thereof, in which case it is necessary to re-activate the function while deleting another extended function. In the present embodiment, the extended functions are given deletion priorities based on, for example, how frequently they are used by the user, so that the addition and deletion of functions do not occur unnecessarily frequently.

In the module information of the present embodiment illustrated in FIG. 9, the still image processing module 113, the AV play module 114 and the voice communications module 115 are given priority values of 7, 5 and 2, respectively, based on how frequently they are used by the user. A smaller media module priority value indicates a higher priority.

When the module determination section 323 receives, as a control signal, a module determination request from the congestion analysis section 322, the module determination section 323 reads out the module information and the media module status information from the database section 321 and searches for a media module having the lowest media module priority from among the active media modules. As a result, the module determination section 323 outputs, as a control signal, the name of the media module found to the congestion analysis section 322.

If a module determination request is issued again from the congestion analysis section 322 for the same function addition request, the module determination section 323 returns the name of the media module having the second lowest priority to that of the media module whose name has been returned in response to the previous module determination request.

In addition to the functions of the congestion analysis section 222 of the first embodiment, the congestion analysis section 322 has a function of sending, as a control signal, a module determination request to the module determination section 323 in order to determine an extended function to be deleted when a resource congestion is detected while a function addition request is being issued. Then, the congestion analysis section 322 receives, as a control signal, the name of a media module from the module determination section 323.

The flow of the process in which the congestion analysis section 322 of the present embodiment analyzes the congestion and, in the event of resource congestion, deletes an extended function to be deleted found by the module determination section and adds the function being requested, will now be described with reference to the drawings.

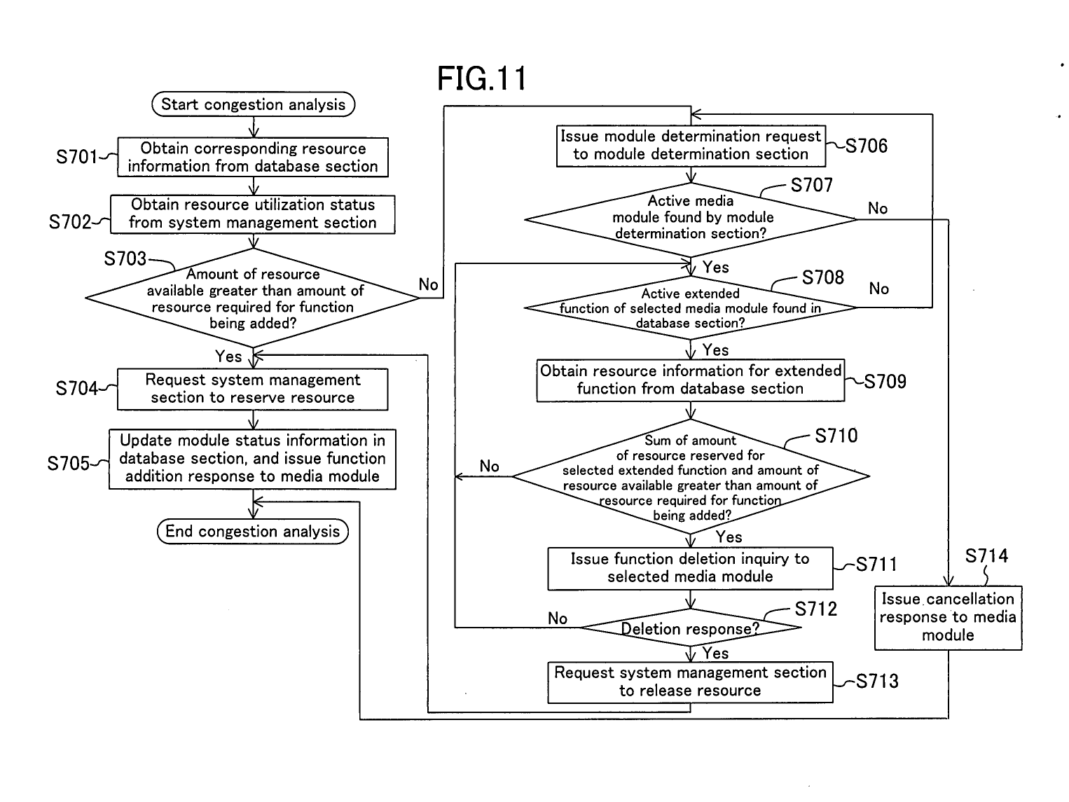

FIG. 11 is a flow chart illustrating the flow of the process to be performed in the event of resource congestion in the media processing method of the present embodiment.

First, in step S701, after receiving a function addition request from a media module, the congestion analysis section 322 retrieves the resource information of the function to be added from the module information in the database section 321, using the name of the module and the name of the extended function included in the request as search keys.

Then, in step S702, the congestion analysis section 322 retrieves the current resource utilization status from the system management section 220.

Then, in step S703, the congestion analysis section 322 compares the amount of resource required for the function being requested to be added with the amount of resource available, for each of the CPU, memory and device resources, based on the resource information and the resource utilization status information obtained in steps S701 and S702. If the amount of resource available is greater than the amount of resource required for the function being added (i.e., “Yes” in this step), the process proceeds to step S704. If the amount of resource available is not sufficient (i.e., “No” in this step), the process proceeds to step S706.

Then, in step S704, if it is possible to allocate the amount of resource required for the function being requested to be added, the congestion analysis section 322 requests the system management section 220 to allocate the CPU, memory and device resources based on the resource information obtained in step S701.

Then, in step S705, the congestion analysis section 322 updates the module status information in the database section 321 in order to register the status of the function added in step S704, and sends a function addition response to the media module that has sent the function addition request. Also when an extended function is deleted in step S713 to be described later, the status of the function is registered in the module status information in the database section 321.

If the amount of resource available is not sufficient for allocating the amount of resource required for the function being requested to be added (i.e., “No” in step S703), the congestion analysis section 322 makes a module determination request to the module determination section 323 in order to determine an extended function to be deleted from among the active extended functions. Then, the congestion analysis section 322 searches for active extended functions of the selected media module to detect an extended function that can be deleted.

First, in step S706, the congestion analysis section 322 sends a module determination request to the module determination section 323 in order to select one media module from among the active media modules based on the module priority.

Then, in step S707, it is determined whether or not there is an active media module. If a response indicating that a media module has been found is returned from the module determination section (i.e., “Yes” in this step), the process proceeds to step S708. If a response indicating that a media module has not been found is returned (i.e., “No” in this step), it is determined that no extended function that can be deleted is found, and the process proceeds to step S714.

Then, in step S708, the congestion analysis section 322 searches through the records of the module status information corresponding to the selected media module starting from the beginning thereof in order to determine an extended function to be deleted from among the active extended functions for the media module selected in step S707. In this step, if an active extended function is found in the module status information (i.e., “Yes” in this step), the process proceeds to step S709. If no active extended function is found in the records of the module status information (i.e., “No” in this step), it is determined that no extended function that can be deleted is found for the selected media module, and the process proceeds to step S706 to repeat the process.

Then, in step S709, the congestion analysis section 322 obtains the resource information of the extended function selected in step S708 from the database section 321.

Then, in step S710, the congestion analysis section 322 compares the amount of resource required for the function being requested to be added with the sum of the amount of resource allocated for the extended function and the amount of resource available, for each of the CPU, memory and device resources, based on the resource information obtained in steps S701, S702 and S709. In this step, if the sum of the amount of resource available and the amount of resource allocated for the extended function being selected is greater than the amount of resource required for the function being added (i.e., “Yes” in this step), the extended function being selected is determined to be the function to be deleted, and the process proceeds to step S711. If the amount of resource required for the function being added cannot be allocated (i.e., “No” in this step), it is determined that the extended function being selected is not a function to be deleted, and the process proceeds to step S708 to repeat the process. If a sufficient resource cannot be allocated by deleting only one function, a plurality of functions to be deleted can be selected when performing the process of this step again.

Then, in step S711, if a function to be deleted has been determined (i.e., “Yes” in step S710), the congestion analysis section 322 makes a function deletion inquiry to the media module selected in step S706, and waits for a response thereto.

Then, in step S712, if the response to the function deletion inquiry made in step S711 is a deletion response (i.e., “Yes” in this step), it is determined that the extended function is to be deleted, and the process proceeds to step S713. If the response is a cancellation response (i.e., “No” in this step), it is determined that the extended function cannot be deleted, and the process proceeds to step S708 to repeat the process.

Then, in step S713, the congestion analysis section 322 requests the system management section 220 to release the CPU, memory and device resources based on the resource information obtained in step S709 in order to delete the extended function to be deleted. Then, the process proceeds to step S704.

If no active media module is found in step S707 (i.e., “No” in step S707), the congestion analysis section 322 sends a function addition cancellation response to the media module that has sent the function addition request in step S714. The congestion analysis is performed as described above.

Now, the congestion analysis of the resource management device of the present embodiment will be described with a specific example.

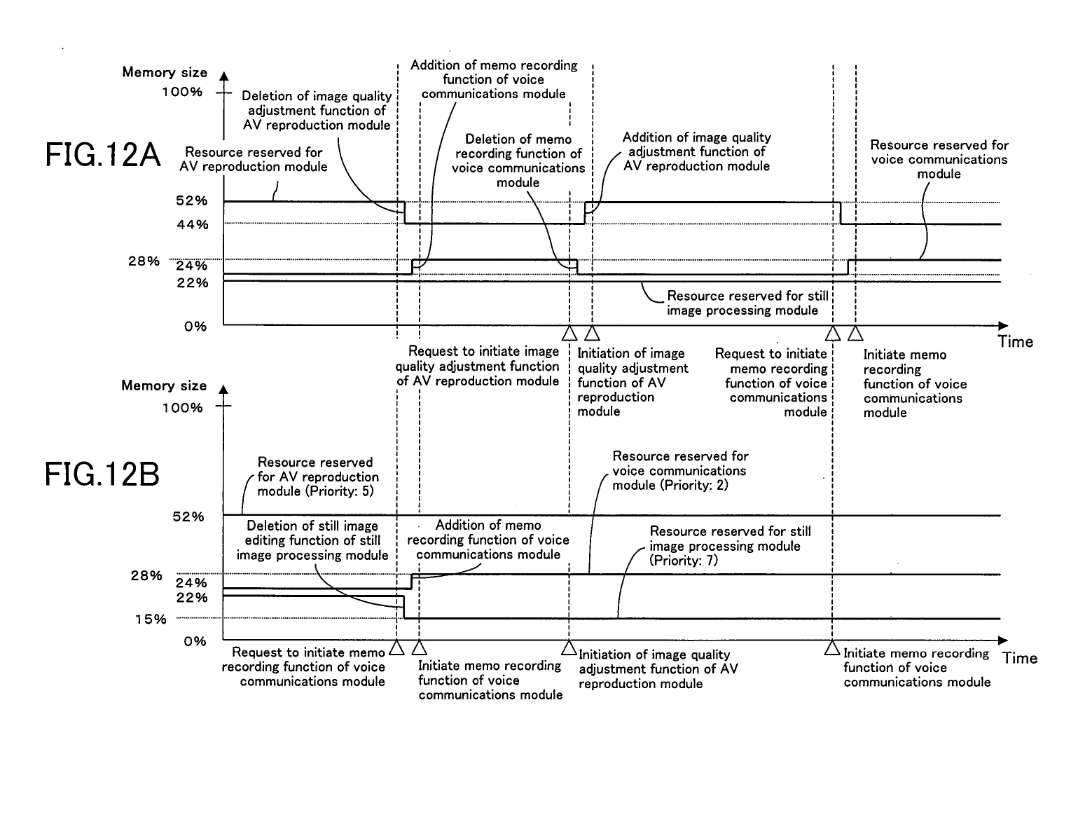

FIG. 12A shows a CPU resource utilization transition in the resource management device of the first embodiment, and FIG. 12B shows that in the resource management device of the present embodiment. These figures show the proportion between the memory resources allocated for the still image processing module 113, the AV play module 114 and the voice communications module 115. Particularly, the figures show a case where two different extended function start requests are issued from different applications one after another in order to show the effectiveness of the media module priority.

In the example shown in FIG. 10, the still image recording function and the still image editing function of the still image processing module 113, the AV play function and the image quality adjustment function of the AV play module 114, and the voice communications function of the voice communications module 115 are being active and available.

Then, if the user issues, via the voice communications application 112, a voice memo recording start request to the voice communications module 115, the voice communications module 115 receives the request and sends a request to add the voice memo recording function to the congestion analysis section 322.

Receiving the voice memo recording function addition request, the congestion analysis section 322 retrieves the resource information of the voice memo recording function (indicating that the function requires a CPU amount of 10 MHz (accounting for 6% of the total CPU resource) and a memory size of 21 KB (accounting for 4% of the total memory resource)) from the module information in the database section 321 as illustrated in FIG. 9, using “voice communications module” and “voice memo recording function” as search keys.

At the same time, the congestion analysis section 322 obtains the following resource utilization status from the system management section 220.

Referring to FIG. 9, as for the CPU resource (160 MHz), 10% thereof is alocated for the still image processing module 113 (5% (8 MHz) for the still image recording function and 5% (7 MHz) for the still image editing function), 55% thereof is allocated for the AV play module 114 (33% (52 MHz) for the AV play function and 22% (35 MHz) for the image quality adjustment function), and 21% thereof (34 MHz) is allocated for the voice communications function of the voice communications module 115, leaving 14% thereof unassigned. Referring to FIG. 12A and FIG. 12B, as for the memory resource (512 KB), 22% thereof is allocated for the still image processing module 113 (15% (78 KB) for the still image recording function and 6% (33 KB) for the still image editing function), 52% thereof is allocated for the AV play module 114 (44% (226 KB) for the AV play function and 8% (39 KB) for the image quality adjustment), and 24% thereof (124 KB) is allocated for the voice communications function of the voice communications module 115, leaving 2% thereof unassigned. Referring to FIG. 9, as for the device resource, the still image processing module 113 is using the LCD 162, the AV play module 114 is using the LCD 162 and the speaker 163, and the voice communications module 115 is using the speaker 163, the microphone 164 and the baseband processor 165.

Then, the congestion analysis section 322 compares the amount of resource required for the voice communications function being requested to be added with the amount of resource available, for each of the CPU, memory and device resources. The comparison indicates that 14% of the CPU resource is available while 6% thereof is being requested. Thus, the congestion analysis section 322 detects no congestion for the CPU resource. As for the memory resource, only 2% thereof is available while 4% thereof is being requested as illustrated in FIG. 12B. Thus, the congestion analysis section 322 detects a congestion for the memory resource. No congestion is detected for the device resource. Thus, based on the congestion detection for the memory resource, it is determined that a resource congestion will occur.

Referring to FIG. 12A, when the resource management device of the first embodiment detects a congestion, the congestion analysis section 222 determines that the function to be deleted is the image quality adjustment function, which is the active extended function closest to the beginning of the module status information illustrated in FIG. 10, and requests the AV play module 114 to delete the function. As a result, the image quality adjustment function is deleted, and the congestion analysis section 222 adds the requested voice memo recording function. Then, the voice communications application 112 starts the voice memo recording function.

If the user later makes an image quality adjustment function start request to the AV play module 114 via the AV play application 111, the congestion analysis section 222 detects a resource congestion and determines that the function to be deleted is the active extended function closest to the beginning of the module status information illustrated in FIG. 10, as illustrated in FIG. 12A. Thus, the congestion analysis section 222 determines that the function to be deleted is the voice memo recording function, which has just been added recently, and deletes the function. Then, the image quality adjustment function is activated.

Then, if the user again makes a voice memo recording function addition request, the congestion analysis section 222 adds the voice memo recording function while deleting the image quality adjustment function, which has just been activated.

As described above, with the resource management device of the first embodiment, addition and deletion of functions may occur each time the user makes an extended function start request. Thus, in such a case where the user uses different extended functions one after another in the presence of a resource congestion, unnecessary overhead may occur for the addition and deletion of functions.

In contrast, when a congestion is detected by the congestion analysis section 322 in the resource management device of the present embodiment, the congestion analysis section 322 sends a module determination request to the module determination section 323 in order to determine an extended function to be deleted.

Receiving the module determination request, the module determination section 323 determines that the function to be deleted is the still image processing module, which has the lowest priority among the active media modules, based on the module information and the module status information illustrated in FIG. 9 and FIG. 10, respectively, and returns the result to the congestion analysis section 322.

After the still image processing module is selected by the module determination section 323, the congestion analysis section 322 searches through the module status information of the still image processing module illustrated in FIG. 10, and successively reads out the active extended functions starting from the beginning thereof. In the illustrated example, the still image editing function is determined to be the function to be deleted and is then deleted, as illustrated in FIG. 12B.

When the user thereafter makes a voice memo recording function start request, the function is already active, whereby it is not necessary to newly add the function while deleting another extended function.

As described above, with the resource management device of the present embodiment, even if the user makes an image quality adjustment function start request and a voice memo recording start request alternately, as illustrated in FIG. 12B, unnecessary addition and deletion of extended functions do not occur. Thus, by assigning each media module a priority value according to how frequently it is used by the user, it is possible to save the time for unnecessary addition and deletion of functions, thereby improving the response speed to a user's request.

Thus, by classifying media processing operation functions into basic functions and extended functions, and by assigning each media module a priority value, resources can be assigned preferentially to a media module whose function is being requested while releasing resources allocated for a media module of a lower priority in the event of resource congestion, thereby realizing an efficient resource assignment. Therefore, with the resource management device of the present embodiment, a plurality of media processing operations can be performed simultaneously with an even higher efficiency than the first embodiment.

While media modules are assigned priority values based on how frequently they are used by the user in the media processing method of the present embodiment, how priority values are assigned is not limited to this.

Moreover, a media module priority does not have to be a fixed value, but may alternatively be a dynamically updated value. For example, since frequently-used functions may differ from one user to another, the priority value may be determined based on each user's history of the use of the functions, which may be stored in the memory 151.

Third Embodiment

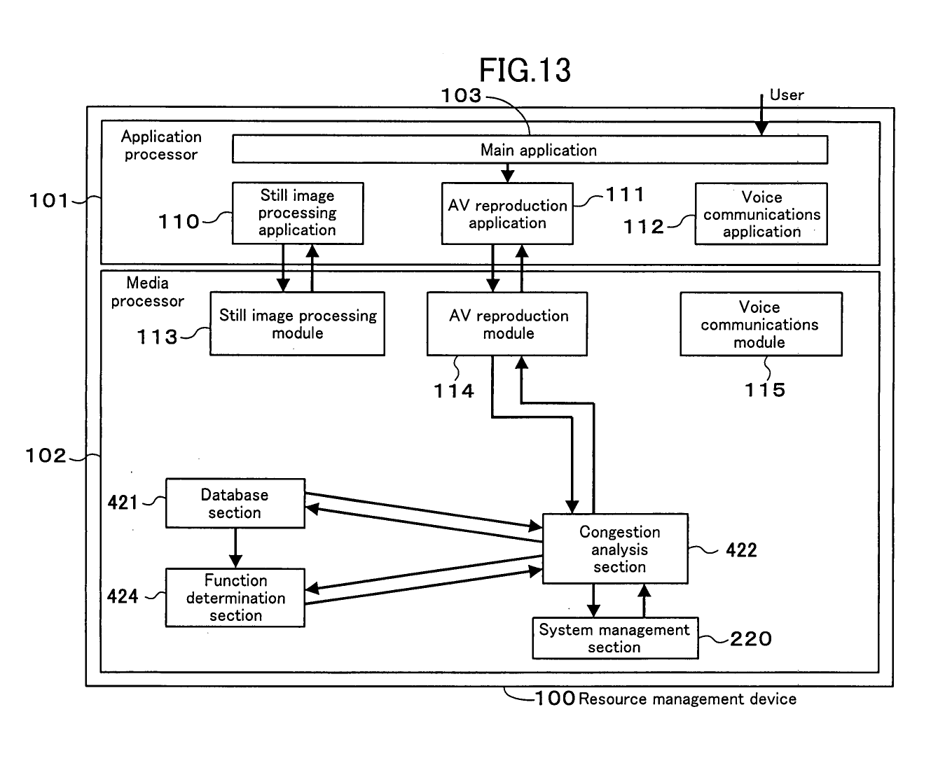

FIG. 13 is a block diagram illustrating an exemplary resource management device according to the third embodiment.

The illustrated resource management device 100 of the present embodiment includes the application processor 101 and the media processor 102.

The application processor 101 includes the main application 103, the still image processing application 110, the AV play application 111 and the voice communications application 112.

The media processor 102 includes the still image processing module 113, the AV play module 114, the voice communications module 115, the system management section 220, a congestion analysis section 422, a database section 421 and a function determination section 424.

The resource management device of the present embodiment differs from the resource management device of the first embodiment in that the function determination section 424 is provided in the media processor 102. The database section 421 and the congestion analysis section 422 correspond to the database section 221 and the congestion analysis section 222, respectively.

The congestion analysis by the resource management device of the present embodiment will now be described.

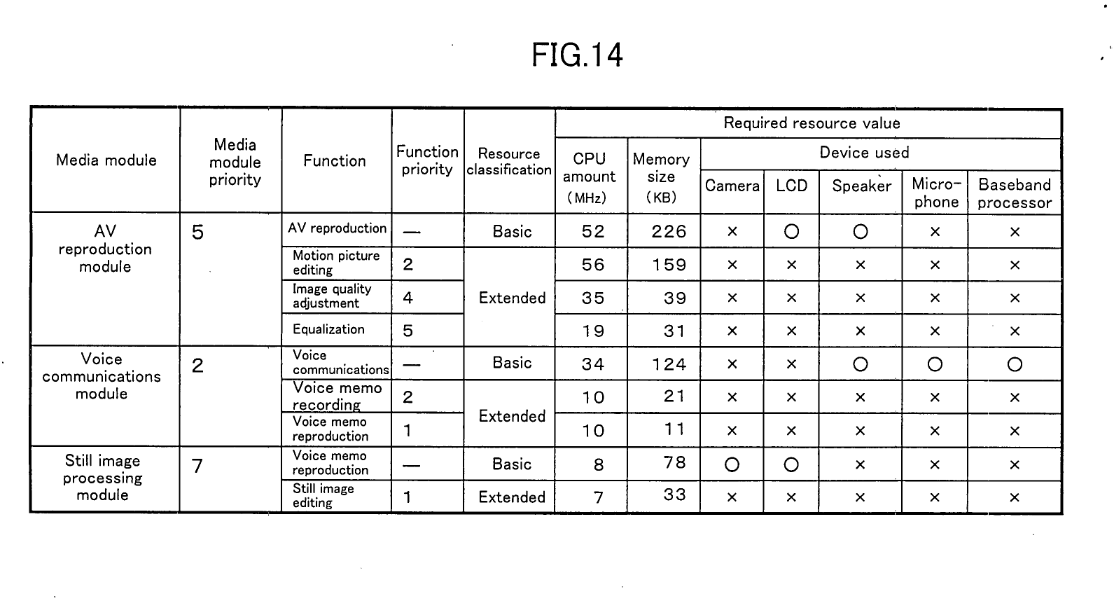

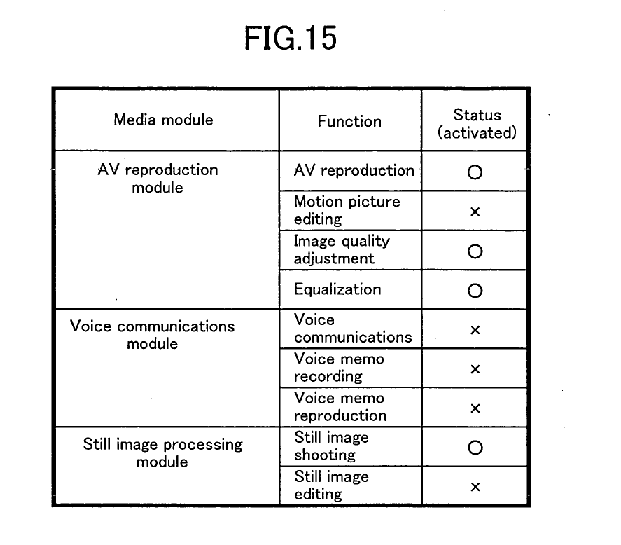

FIG. 14 illustrates exemplary module information stored in the database section 421 in the resource management method of the present embodiment, and FIG. 15 illustrates exemplary module status information stored in the database section 421 in the media processing method of the present embodiment.

The module information illustrated in FIG. 14 and the module status information illustrated in FIG. 15 are both stored in the database section 421. The module information includes the function information, the resource information and the media module priority. The module priority is the same as that illustrated in the second embodiment. In addition, the module information of the present embodiment includes the function priority.

The function priority is an indication with which an extended function to be deleted can be decided from among extended functions of the media module selected by using the module priority in the event of resource congestion. Therefore, as in the first and second embodiments, the basic function has no priority value.

In the resource management device of the second embodiment, the module determination section 323 selects a module of the lowest priority as the module whose function is to be deleted in the event of resource congestion. However, there may be a case where a module as a whole has a low priority but has a function that is used frequently. In such a case, an extended function may be needed soon after the deletion thereof, whereby it is necessary to add the function while removing another extended function. In view of this, in the media processing method of the present embodiment, the extended functions included in each module are assigned priority values, so that a function to be deleted is determined with reference to the function priority in the event of resource congestion.

In the present embodiment, the still image processing module 113, the AV play module 114 and the voice communications module 115 are given priority values of 7, 5 and 2, respectively, based on how frequently they are used by the user, as illustrated in FIG. 14. Within the AV play module 114, the motion picture editing function, the image quality adjustment function and the equalization function are given priority values of 2, 4 and 5, respectively, based on how frequently they are used by the user. A smaller value indicates a higher priority both for the media module priority and the function priority.

The function determination section 424 receives, as a control signal, a function determination request from the congestion analysis section 422, in response to which the function determination section 424 reads out the module information and the media module status information from the database section 421 and selects one of the active media modules that has the lowest media module priority. Then, the function determination section 424 selects one of the active extended function of the selected media module that has the lowest function priority as the extended function to be deleted. Then, the function determination section 424 returns the result to the congestion analysis section 422 as a control signal.

If a function determination request is issued again from the congestion analysis section 422 for the same function addition request, the function determination section 424 returns the extended function having the second lowest priority to that of the extended function that has been returned in response to the previous function determination request.

In addition to the functions of the congestion analysis section 222 of the first embodiment, the congestion analysis section 422 has a function of sending, as a control signal, a function determination request to the function determination section 424 in order to determine an extended function to be deleted when a resource congestion is detected while a function addition request is being issued, and receiving the selected extended function as a control signal.

Now, the flow of the congestion analysis performed by the congestion analysis section 422 of the resource management device of the present embodiment will be described.

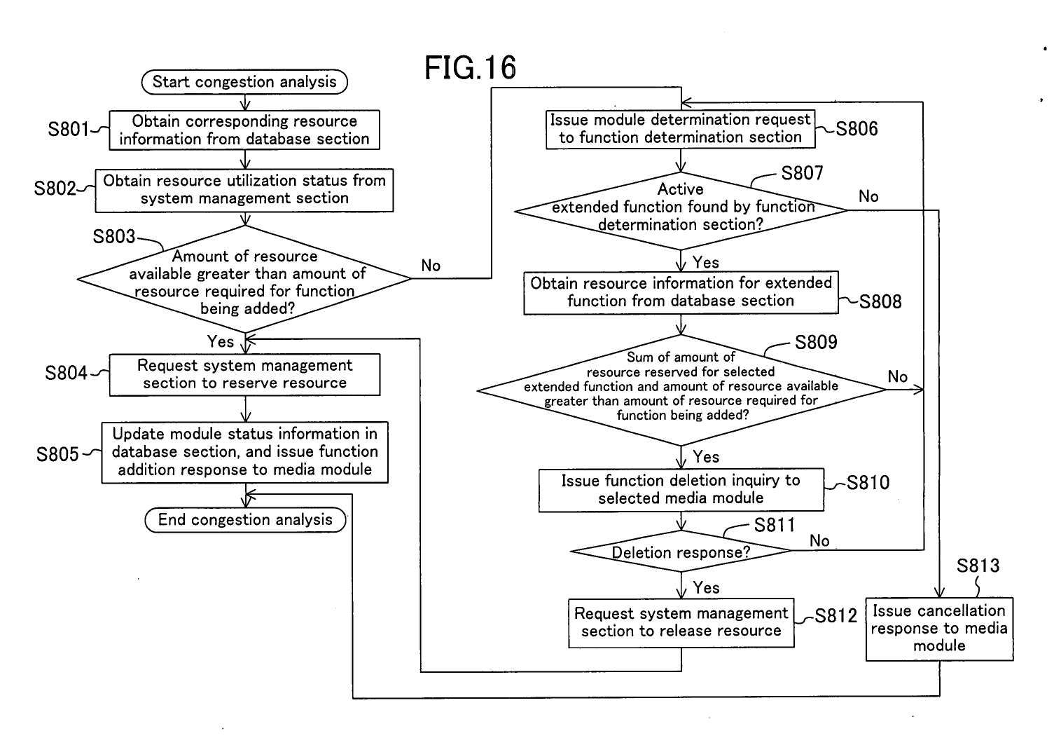

FIG. 16 is a flow chart illustrating the flow of the process to be performed in the event of resource congestion in the media processing method of the present embodiment.

First, in step S801, in response to a function addition request from a media module, the congestion analysis section 422 retrieves the resource information for the module whose function is being requested to be added from the module information in the database section 421, using the name of the module and the name of the extended function included in the function addition request as search keys.

Then, in step S802, the congestion analysis section 422 obtains the current resource utilization status from the system management section 220.

Then, in step S803, the congestion analysis section 422 compares the amount of resource required for the function being requested to be added with the amount of resource available, for each of the CPU, memory and device resources, based on the resource information obtained in steps S801 and S802. If the amount of resource available is greater than the amount of resource required for the function to be added (i.e., “Yes” in this step), the process proceeds to step S804. If the amount of resource available is not sufficient (i.e., “No” in this step), the process proceeds to step S806.

Then, in step S804, if it is possible to allocate the amount of resource required for the function being requested to be added (i.e., “Yes” in step S803), the congestion analysis section 422 requests the system management section 220 to allocate the CPU, memory and device resources based on the resource information obtained in step S801.

Then, in step S805, the congestion analysis section 422 updates the module status information in the database section 421 in order to register the status of the function added in step S804, and sends a function addition response to the media module that has sent the function addition request. Also when an extended function is deleted in step S812 to be described later, the status of the function is registered in the module status information in the database section 421.

In step S806, if it is not possible to allocate the amount of resource required for the function being requested to be added (i.e., “No” in step S803), the congestion analysis section 422 makes a function determination request to the function determination section 424 in order to determine an extended function to be deleted from among the active extended functions.

Then, in step S807, the congestion analysis section 422 receives a response from the function determination section 424. If the function determination section returns a response indicating that an extended function has been found (i.e., “Yes” in this step), the process proceeds to step S808. If the function determination section returns a response indicating that no active extended function has been found (i.e., “No” in this step), it is determined that no extended function that can be deleted is found, and the process proceeds to step S813.

Then, in step S808, the congestion analysis section 422 obtains the resource information of the extended function selected in step S807 from the database section 421.

Then, in step S809, the congestion analysis section 422 compares the amount of resource required for the function being requested to be added with the sum of the amount of resource allocated for the extended function and the amount of resource available, for each of the CPU, memory and device resources, based on the resource information obtained in steps S801, S802 and S808. If the sum of the amount of resource available and the amount of resource allocated for the extended function being selected is greater than the amount of resource required for the function being added (i.e., “Yes” in this step), the extended function being selected is determined to be the function to be deleted, and the process proceeds to step S810. If the amount of resource required for the function being added cannot be allocated (i.e., “No” in this step), it is determined that the extended function being selected is not a function to be deleted, and the process proceeds to step S806 to repeat the process.

Then, in step S810, if a function to be deleted has been determined (i.e., “Yes” in step S809), the congestion analysis section 422 makes a function deletion inquiry to the media module selected in step S806, and waits for a response thereto.

Then, in step S811, if the response to the function deletion inquiry made in step S810 is a deletion response (i.e., “Yes” in this step), it is determined that the extended function is to be deleted, and the process proceeds to step S812. If the response is a cancellation response (i.e., “No” in this step), it is determined that the extended function cannot be deleted, and the process proceeds to step S806 to repeat the process.

Then, in step S812, the congestion analysis section 422 requests the system management section 220 to release the CPU, memory and device resources based on the resource information obtained in step S808 in order to delete the extended function to be deleted. Then, the process proceeds to step S804.

If no extended function that can be deleted is found in step S806 (i.e., “No” in step S807), the congestion analysis section 422 sends a function addition cancellation response to the media module that has sent the function addition request in step S813. The congestion analysis is performed as described above.

Now, the congestion analysis of the resource management device of the present embodiment will be described with a specific example.

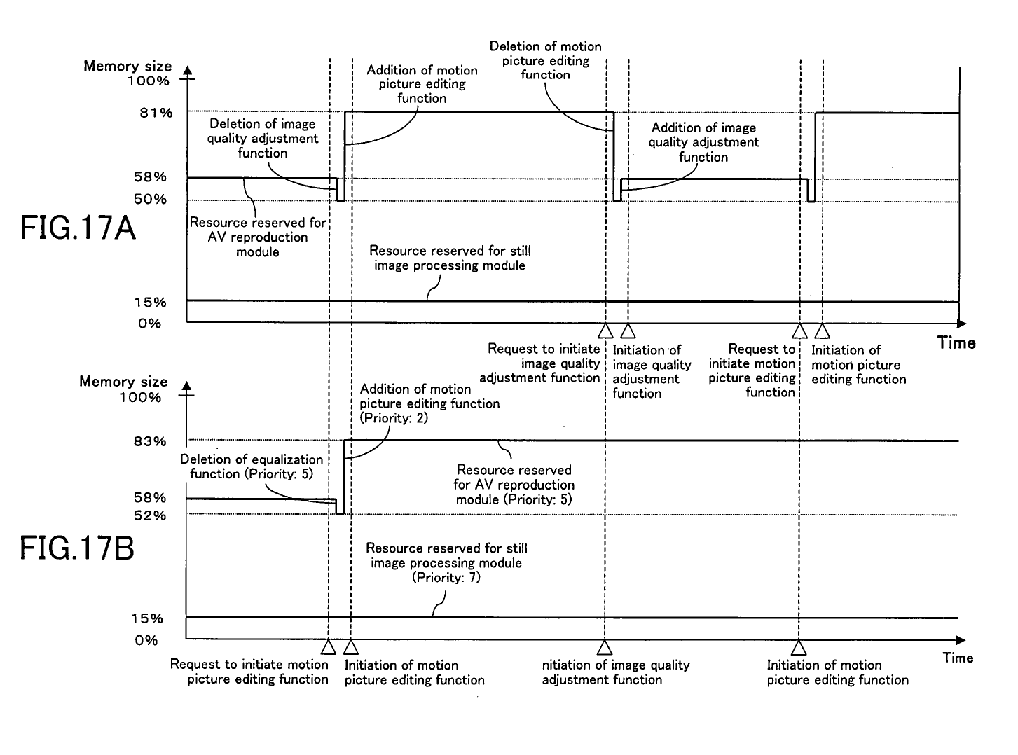

FIG. 17A shows a memory resource utilization transition in the resource management device of the first embodiment, and FIG. 17B shows that in the resource management device of the present embodiment. FIG. 17A and FIG. 17B show the transition of the proportion of the memory resource allocated by the AV play module 114 for a combination of the AV play function, the motion picture editing function, the image quality adjustment function and the equalization function. Particularly, the figures show a case where two different extended function start requests are issued from an application one after another in order to show the effectiveness of the function priority.

As shown in the module status information of FIG. 15, the AV play function, the image quality adjustment function and the equalization function of the AV play module 114 and the still image recording function of the still image processing module 113 are being active and available.

Then, if the user issues, via the AV play application 111, a motion picture editing start request to the AV play module 114, the AV play module 114 receives the request and sends a request to add the motion picture editing function to the congestion analysis section 422.

Receiving the motion picture editing function addition request, the congestion analysis section 422 retrieves the resource information of the motion picture editing function (indicating that the function requires a CPU amount of 56 MHz (accounting for 35% of the total CPU resource) and a memory size of 159 KB (accounting for 31% of the total memory resource)) from the module information as illustrated in FIG. 14, using “AV play module” and “motion picture editing function” as search keys.

At the same time, the congestion analysis section 422 obtains the following resource utilization status from the system management section 220.

Referring to FIG. 14, as for the CPU resource (160 MHz), 5% thereof (8 MHz) is allocated for the still image recording function of the still image processing module 113, and 67% thereof is allocated for the AV play module 114 (33% (52 MHz) for the AV play function, 22% (35 MHz) for the image quality adjustment function and 12% (19 MHz) for the equalization function), leaving 28% thereof unassigned. Referring to FIG. 17A and FIG. 17B, as for the memory resource (512 KB), 15% thereof (78 KB) is allocated for the still image recording function of the still image processing module 113, and 58% thereof is allocated for the AV play module 114 (44% (226 KB) for the AV play function, 8% (39 KB) for the image quality adjustment function and 6% (31 KB) for the equalization function), leaving 27% thereof unassigned. As for the device resource, the still image processing module 113 is using the LCD 162, and the AV play module 114 is using the LCD 162 and the speaker 163.

The congestion analysis section 422 compares the amount of resource required for the motion picture editing function, which is the function being requested to be added, with the amount of resource available, for each of the CPU, memory and device resources. The comparison indicates that only 28% of the CPU resource is available while 35% thereof is being requested. Thus, the congestion analysis section 422 detects a congestion for the CPU resource. As for the memory resource, only 27% thereof is available while 31% thereof is being requested as illustrated in FIG. 17A and FIG. 17B. Thus, the congestion analysis section 422 detects a congestion for the memory resource. No congestion is detected for the device resource. Thus, it is determined that a resource congestion will occur.

Referring to FIG. 17A, when the resource management device of the first embodiment detects a congestion, the congestion analysis section 222 determines that the function to be deleted is the image quality adjustment function, which is the active extended function closest to the beginning of the module status information illustrated in FIG. 15, and requests the AV play module 114 to delete the function. As a result, the image quality adjustment function is deleted, and the congestion analysis section 222 adds the requested motion picture editing function. Then, the AV play application 111 starts the motion picture editing function.

If the user later makes an image quality adjustment function start request to the AV play module 114 via the AV play application 111, the congestion analysis section 222 detects a resource congestion and determines that the function to be deleted is the active extended function closest to the beginning of the module status information illustrated in FIG. 15, as illustrated in FIG. 17A. Thus, the function to be deleted is the motion picture editing function, which has just been added recently. Then, the image quality adjustment function is activated after determining that the motion picture editing function is to be deleted. In the example shown in FIG. 17A, a motion picture editing function start request is thereafter issued again, whereby the motion picture editing function is added while deleting the image quality adjustment function again. In this example, addition and deletion of functions occur each time the user makes an extended function start request.

Thus, in such a case where the user uses different extended functions one after another in the presence of a resource congestion, unnecessary overhead may occur for the addition and deletion of functions, particularly if the functions to be deleted are functions that are frequently used.

In contrast, when a congestion is detected by the congestion analysis section 422 in the resource management device of the present embodiment, the congestion analysis section 422 sends a function determination request to the function determination section 424 in order to determine an extended function to be deleted.

Receiving the function determination request, the function determination section 424 selects the still image processing module having the lowest priority among the active media modules, based on the module information and the module status information illustrated in FIG. 14 and FIG. 15, respectively. However, no extended function of the still image processing module is being active. Therefore, the function determination section 424 then selects the AV play module having the second lowest priority and selects the equalization function having the lowest priority among the active extended functions of the AV play module. As a result, the function determination section 424 returns “equalization function” to the congestion analysis section 422.

After the equalization function is selected by the function determination section 424, the congestion analysis section 422 performs a resource calculation to determine whether or not the equalization function can be the function to be deleted. In the illustrated example, the equalization function is determined to be the function to be deleted and is then deleted, as illustrated in FIG. 17B. Thereafter, the amount of memory resource available is 52%, allowing for the addition of the motion picture editing function.

When the user thereafter makes an image quality adjustment function start request to the AV play module 114 via the AV play application 111, the image quality adjustment function is kept active, whereby it is not necessary to delete and add functions. As described above, with the resource management device of the present embodiment, even if the user makes a motion picture editing function start request and an image quality adjustment function start request alternately, as illustrated in FIG. 17B, unnecessary addition and deletion of extended functions do not occur. While the media modules and the extended functions are given priorities as shown in FIG. 14 in this example, the priorities are not limited to those shown in FIG. 14 as long as higher priorities are given to media modules that are more frequently used by the user and higher priorities are given to extended functions of each media module that are more frequently used by the user. Then, addition and deletion of functions will occur less frequently, thereby improving the response to a user's request.

With the resource management device of the present embodiment, not only the media modules but also the extended functions of each media module are given priorities, whereby resources can be assigned preferentially to extended functions of higher priorities while releasing resources allocated for extended functions of lower priorities in the event of resource congestion, thereby further improving the response to a user's request.

While extended functions are assigned priority values based on how frequently they are used by the user in the present embodiment, how priority values are assigned is not limited to this. Moreover, a function priority may alternatively be a dynamically updated value. For example, the function priority values may be varied from one user to another based on how frequently the functions are used by the users.

While module priorities and extended function priorities are both set in the present embodiment, only extended function priorities may be set without setting module priorities. In such a case, the function priorities are set regardless of which module each function belongs to, and the function to be deleted is determined to be the one having the lowest function priority among all the functions of various modules.

Fourth Embodiment

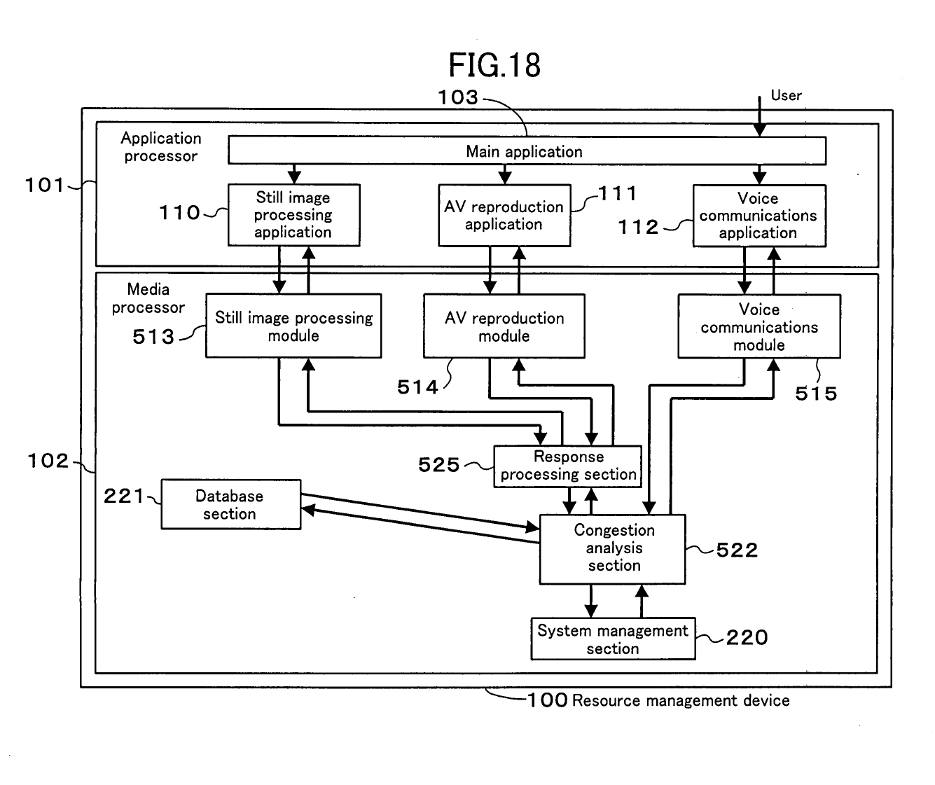

FIG. 18 is a block diagram illustrating an exemplary resource management device according to the fourth embodiment.

The illustrated resource management device 100 of the present embodiment includes the application processor 101 and the media processor 102.

The application processor 101 includes the main application 103, the still image processing application 110, the AV play application 111 and the voice communications application 112.

The media processor 102 includes a still image processing module 513, an AV play module 514, a voice communications module 515, the system management section 220, a congestion analysis section 522, the database section 221 and a response processing section 525.

The resource management device of the present embodiment differs from the resource management device of the first embodiment in that the response processing section 525 is provided in the media processor 102. The still image processing module 513, the AV play module 514, the voice communications module 515 and the congestion analysis section 522 correspond to the still image processing module 113, the AV play module 114, the voice communications module 115 and the congestion analysis section 222, respectively.

The congestion analysis by the resource management device of the present embodiment will now be described.

The response processing section 525 receives one or more deletion inquiries sent as a control signal from the congestion analysis section 522. In the resource management device of the present embodiment, one or more deletion inquiries are sent to the response processing section 525 substantially simultaneously. A deletion inquiry is related to the deletion of an extended function associated with the deletion inquiry and the media module supporting the extended function.

Receiving a deletion inquiry, the response processing section 525 stores the name of the extended function associated with the deletion inquiry and the name of the media module supporting the extended function, and sends, as a control signal, a function deletion inquiry to the media module included in the deletion inquiry. In response to the function deletion inquiry, the response processing section 525 receives, as a control signal, a permission response or a cancellation response from the media module.

The response processing section 525 sends, as a control signal, a deletion request to the media module issuing a permission response that was received first. The response processing section 525 sends, as a control signal, a cancellation response to the media modules issuing permission responses that were received as second and subsequent permission responses.

Then, after receiving, as a control signal, a deletion response in response to the deletion request sent to a media module, the response processing section 525 returns, to the congestion analysis section 522, a deletion response for an extended function of the media module, from which it has received the deletion response.

The control signals are sent from and received by the response processing section 525 in the following sequence.

(1) Send function deletion inquiries to one or more media modules.

(2) Receive either a permission response or a cancellation response from a media module.

(3-1-1) If the received response is a permission response and is the first response received, send a deletion request to the media module that has issued the response.

(3-1-2) Receive, from the media module, a deletion response in response to the deletion request.

(3-2) If the received response is a permission response and is the second or subsequent response received, send a cancellation response to the media module that has issued the response.

(3-3) Sequence ends if the received response is a cancellation response.

With the resource management device of the first embodiment, the congestion analysis section 222 can issue only one function deletion inquiry to one media module at once. Therefore, if a media module that is slow in responding to an inquiry is selected from among a plurality of media modules to be deleted, the response to a user's request may possibly become slow. The resource management device of the present embodiment provides an improvement with respect to this problem.

Each of the still image processing module 513, the AV play module 514 and the voice communications module 515 operates as it does in the first embodiment, but further operates as follows with the additional provision of the response processing section 525.

A media module supporting an extended function that has been selected as a function to be deleted in the event of resource congestion receives a function deletion inquiry from the response processing section 525. Receiving the function deletion inquiry, the media module returns a permission response when permitting the deletion or a cancellation response when not permitting the deletion. In this process, an inquiry to an application may be made as necessary.

A deletion request is sent from the response processing section 525 to one of the media modules that has first sent the permission response to the response processing section 525.

Then, receiving the deletion request, the media module terminates the extended function to be deleted, and returns a deletion response.

A cancellation response is sent from the response processing section 525 to other media modules issuing the second and subsequent permission responses to the response processing section 525.

A media module receiving the cancellation response can continue the media processing operation.

Now, the flow of the congestion analysis performed by the congestion analysis section 522 and the response processing section 525 of the resource management device of the present embodiment will be described.

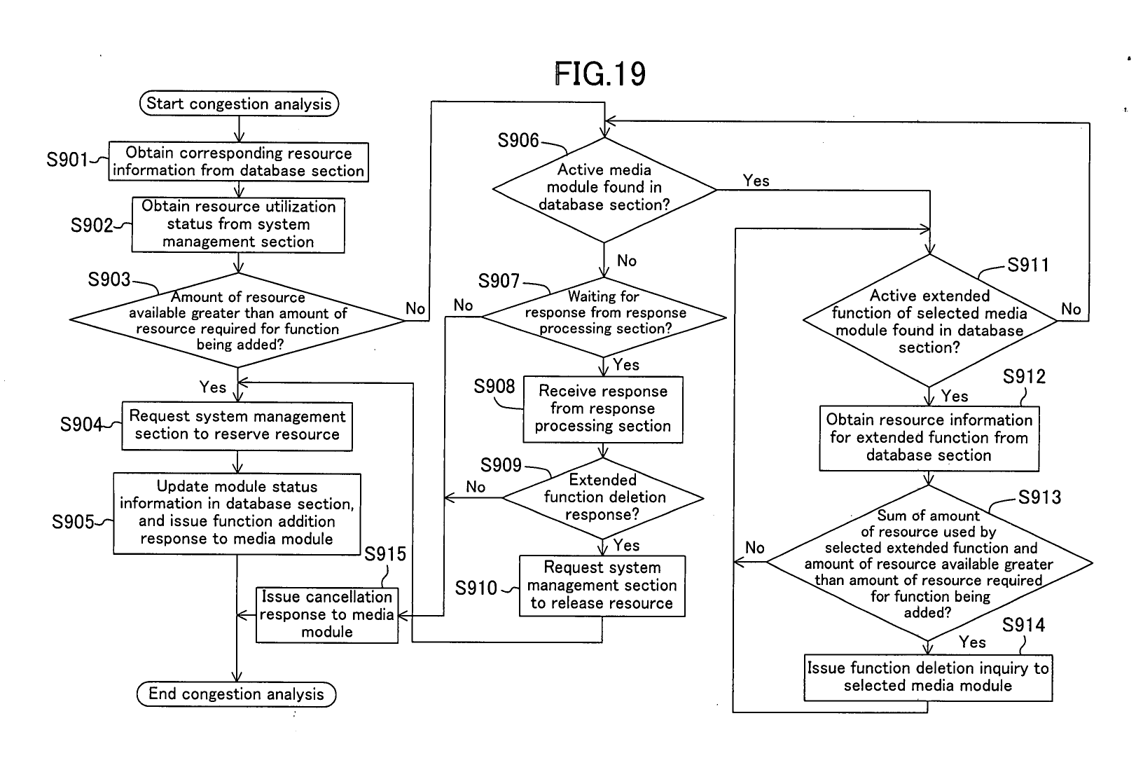

FIG. 19 is a flow chart illustrating the flow of the process to be performed in the event of resource congestion in the media processing method of the present embodiment.

First, in step S901, the congestion analysis section 522 receives a function addition request from a media module, and retrieves the resource information for the function to be added from the module information of the database section 221 using the name of the media module and the name of the extended function included in the function addition request as search keys.

Then, in step S902, the congestion analysis section 522 retrieves the current resource utilization status from the system management section 220.

Then, in step S903, based on the resource information obtained in steps S901 and S902, the congestion analysis section 522 compares the amount of resource required for the function being requested to be added with the amount of resource available, for each of the CPU, memory and device resources. If the amount of resource available is greater than the amount of resource required for the function being added (i.e., “Yes” in this step), the process proceeds to step S904. If the amount of resource available is not sufficient (i.e., “No” in this step), the process proceeds to step S906.

Then, in step S904, if it is possible to allocate the amount of resource required for the function being requested to be added (i.e., “Yes” in step S903), the congestion analysis section 522 requests the system management section 220 to allocate the CPU, memory and device resources based on the resource information obtained in step S901. Then, in step S905, the congestion analysis section 522 updates the module status information in the database section 221 in order to register the status of the function added in step S904, and sends a function addition response to the media module that has sent the function addition request. Also when an extended function is deleted in step S910 to be described later, the status of the function is registered in the module status information in the database section 221.

If it is not possible to allocate the amount of resource required for the function being requested to be added (i.e., “No” in step S903), the congestion analysis section 522 selects a plurality of extended functions that can be deleted from among all the active extended functions. Specifically, the congestion analysis section 522 searches for active media modules from the database section 221 and then searches for active extended function from the selected media modules to detect extended functions that can be deleted.

First, in step S906, the congestion analysis section 522 searches through the module status information stored in the database section 221 starting from the beginning thereof to find active media modules. If an active media module is found (i.e., “Yes” in this step), the process proceeds to step S911. If no active media module is found in the records of the module status information (i.e., “No” in this step), the process proceeds to step S907.

Then, in step S907, if a response from the response processing section 525 is being waited for (i.e., “Yes” in this step), the process proceeds to step S908. Otherwise (i.e., “No” in this step), it is determined that no extended function that can be deleted is found, and the process proceeds to step S915.

Then, in step S908, the congestion analysis section 522 receives a response to a function deletion inquiry from the response processing section 525.

Then, in step S909, if the response received from the response processing section 525 in step S908 is an extended function deletion response (i.e., “Yes” in this step), the process proceeds to step S910. If the received response is a cancellation response (i.e., “No” in this step), it is determined that no extended function that can be deleted is found, and the process proceeds to step S915.

Then, in step S910, in order to delete the extended function that has been determined to be deleted, the congestion analysis section 522 requests the system management section 220 to release the CPU, memory and device resources based on the resource information obtained in step S912 to be described later. Then, the process proceeds to step S904.

In step S911, the congestion analysis section 522 searches through the records of the module status information for the media module selected in step S906 starting from the beginning thereof in order to select one extended function from among the active extended functions. If an active extended function is found in the module status information (i.e., “Yes” in this step), the process proceeds to step S912. If no active extended function is found in the records of the module status information (i.e., “No” in this step), the process proceeds to step S906.

Then, in step S912, the congestion analysis section 522 obtains, from the database section 221, the resource information of the extended function selected in step S911.

Then, in step S913, the congestion analysis section 522 compares the amount of resource required for the function being requested to be added with the sum of the amount of resource allocated for the extended function and the amount of resource available, for each of the CPU, memory and device resources, based on the resource information obtained in steps S912, S901 and S902. If the sum of the amount of resource available and the amount of resource allocated for the selected extended function is greater than the amount of resource required for the function being added (i.e., “Yes” in this step), the selected extended function is determined to be the extended function to be deleted, and the process proceeds to step S914. If the amount of resource required for the function being added cannot be allocated (i.e., “No” in this step), it is determined that the extended function being selected is not a function to be deleted, and the process proceeds to step S911 to repeat the process.

Then, in step S914, if a function to be deleted has been determined (i.e., “Yes” in step S913), the congestion analysis section 522 makes a function deletion inquiry to the media module selected in step S906, and the process proceeds to step S911 to search for the next function to be deleted. The congestion analysis of the present embodiment is performed as described above.

Now, the process performed by the resource management device of the present embodiment will be described with a specific example.

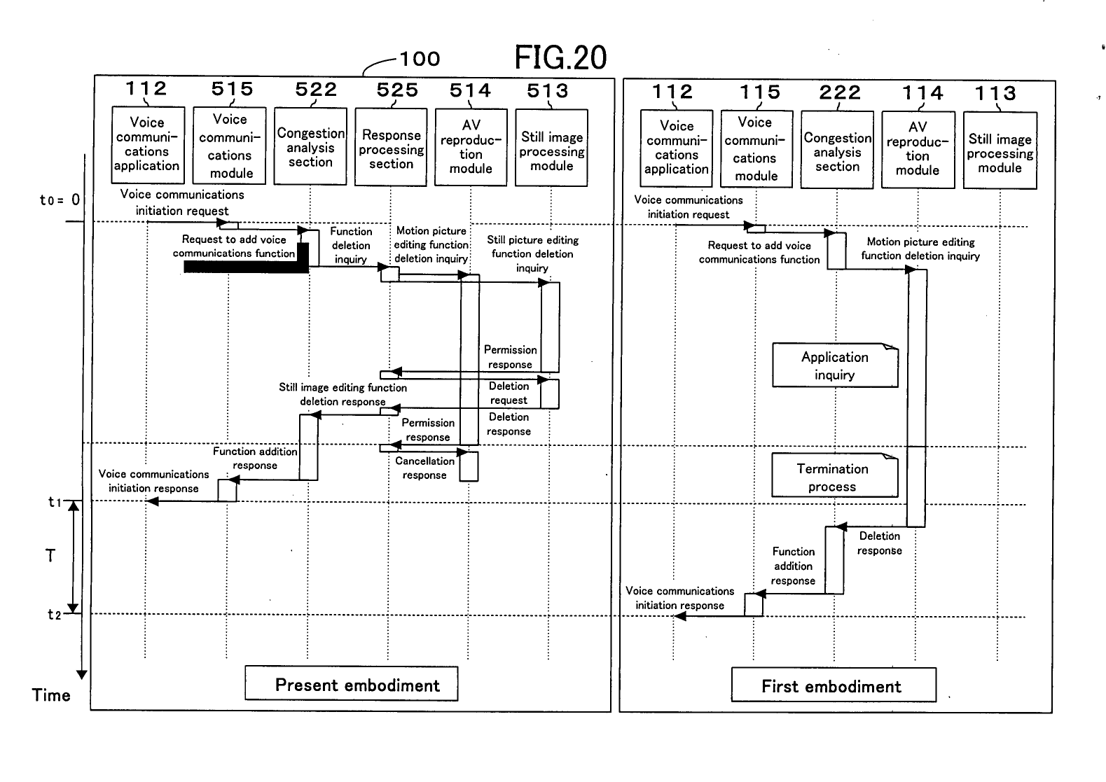

FIG. 20 shows a sequence of signal exchanges between various blocks in the resource management device of the first embodiment and that in the resource management device of the present embodiment in a case where a voice communications start request is issued from the voice communications application. FIG. 20 shows a case where the motion picture editing function, having the slowest response speed, is in the record closest to the beginning of the database and is thus selected in the function addition process, so that it is easy to compare the embodiments in terms of the response time required from when a voice communications start request is issued from the voice communications application 112 until a response thereto is returned. In the illustrated example, the still image editing function is shown to be a function having the fastest response speed.

Where a voice communications start request is sent from the voice communications application 112 to the voice communications modules 115 and 515 (at time t0=0) with the motion picture editing function of the AV play modules 114 and 514 and the still image editing function of the still image processing modules 113 and 513 being available, the voice communications modules 115 and 515, receiving the voice communications start request, send a voice communications function addition request to the congestion analysis sections 222 and 522, respectively.

In the resource management device of the present embodiment, the congestion analysis section 522 receiving the voice communications function addition request detects a resource congestion, and selects the still image editing function of the still image processing module 513 and the motion picture editing function of the AV play module 514 as extended functions to be deleted. Then, the congestion analysis section 522 issues a still image editing function deletion inquiry and a motion picture editing function deletion inquiry to the response processing section 525.

Receiving the still image editing function deletion inquiry and the motion picture editing function deletion inquiry, the response processing section 525 sends a still image editing function deletion inquiry and a motion picture editing function deletion inquiry to the still image processing module 513 and the AV play module 514, respectively.

Receiving the still image editing function deletion inquiry, the still image processing module 513 makes an inquiry to the still image processing application 110, and consequently returns a permission response to the response processing section 525.

Receiving the motion picture editing function deletion inquiry, the AV play module 514 similarly makes an inquiry to the AV play application 111, and consequently returns a permission response to the response processing section 525.

In this case, since the still image processing module 513 has returned the permission response earlier than the AV play module 514, the still image processing module 513 receives a deletion request from the response processing section 525, and the AV play module 514 receives a cancellation response from the response processing section 525.

Receiving the deletion request, the still image processing module 513 terminates the still image editing function, and returns a deletion response to the response processing section 525.

The AV play module 514 receiving the cancellation response can keep the motion picture editing function without deleting it.

Then, the response processing section 525 receiving the deletion response returns a still image editing function deletion response to the congestion analysis section 522. Then, receiving the deletion response, the congestion analysis section 522 releases the resources being used by the still image editing function, allocates resources for the voice communications function, and returns a function addition response to the voice communications module 515.

Receiving the function addition response, the voice communications module 515 returns a voice communications start response to the voice communications application 112 (at time t1).

In the resource management device of the first embodiment, the congestion analysis section 222 makes deletion inquiries for extended functions registered in the database section 221 starting from the beginning thereof. Thus, the congestion analysis section 222 first makes a motion picture editing function deletion inquiry to the AV play module 114.

Then, receiving the motion picture editing function deletion inquiry, the AV play module 114 makes an inquiry to the AV play application 111, and consequently obtains a motion picture editing function termination request.

Then, the AV play module 114 terminates the motion picture editing function in response to the motion picture editing termination request, and returns a deletion response to the congestion analysis section 222.

Receiving the deletion response, the congestion analysis section 222 releases the resources being used by the motion picture editing function, allocates resources for the voice communications function, and returns a function addition response to the voice communications module 115.

Receiving the function addition response, the voice communications module 115 returns a voice communications start response to the voice communications application 112 (at time t2).

As shown in FIG. 20, with the resource management device of the first embodiment, it takes an amount of time t2 from the issuance of the voice communications start request until a response thereto is returned. In contrast, in the resource management device of the present embodiment, the response processing section selects a fast-responding extended function from among the extended functions that can be deleted, whereby it takes only an amount of time t1 from the issuance of the voice communications start request until a response thereto is returned. Thus, the response time is shortened by time T.

Thus, with the resource management device of the present embodiment, a fast-responding media module can be selected from among those that can be deleted, whereby it is possible to shorten the response time of an application for a function addition request.

Therefore, it is possible to improve the speed of the media processing operation while efficiently utilizing the resources.

While it has been assumed in the above description of the present embodiment that function addition requests from media modules do not overlap with each other, it is possible with the present embodiment to shorten the response time for each of a plurality of function addition requests that are made simultaneously from a plurality of media modules.

While the response processing section is added in the present embodiment to the resource management device of the first embodiment, it is also effective to add the response processing section to the resource management device of the second or third embodiment. In such a case, a module of a low priority is selected and two or more extended functions of low priorities are successively selected as extended functions to be deleted in response to an extended function addition request.

In the illustrated example above, the response processing section 525 simultaneously receives two or more extended function deletion inquiries. In a case where there are a number of modules and the function deletion operation is performed on a module-by-module basis, deletion inquiries for a plurality of modules will be made.

Any of the resource management methods of the embodiments of the present invention can be implemented by, for example, a program stored internally in or externally to the resource management device.

1. A resource management device, comprising a media processor including:
a media module for performing a media processing operation;
a congestion analysis section for, if it is determined that a resource congestion will occur as a result of a function addition request being issued, changing a resource assignment by referencing module information and module status information, the module information including function information for the media module and resource information for the media processing function, and the module status information indicating whether or not the media processing function is being active; and
a system management section for allocating and releasing resources according to the resource assignment changed by the congestion analysis section.

2. The resource management device of claim 1, further comprising a database section storing the module information and the module status information.

3. The resource management device of claim 1, wherein:
the media processing function includes a basic function, which is essential for the media processing operation, and an extended function, which is an additional function; and
if it is determined that a resource congestion will occur as a result of a function addition request being issued, the congestion analysis section activates a function for which the addition request has been issued after deleting the extended function being active.

4. The resource management device of claim 3, wherein:
there are a plurality of media modules;
the module information includes a media module priority; and
the media processor further includes a module determination section for, if it is determined that a resource congestion will occur, preferentially selecting a media module having a lower media module priority as a media module whose function is to be deleted.

5. The resource management device of claim 3, wherein:
the module information includes a function priority for the extended function; and
the media processor further includes a function determination section for, if it is determined that a resource congestion will occur, preferentially selecting an extended function having a lower function property as an extended function to be deleted.

6. The resource management device of claim 3, wherein
the media processor further includes a response processing section for, if it is determined that a resource congestion will occur, inquiring the media modules as to deletion of a plurality of active extended functions, and deciding to delete at least the extended function of the media module that has returned a response first.

7. A resource management method using a resource management device including a media processor, the media processor including a media module, a congestion analysis section and a system management section, the media module performing a media processing operation including an extended function and a basic function, which is essential for the media processing operation, the method comprising:
a step (a) in which if it is determined that a resource congestion will occur as a result of a function addition request being issued, the congestion analysis section changes a resource assignment by referencing module information and module status information, the module information including function information for the media module and resource information for the media processing function, and the module status information indicating whether or not the media processing function is being active; and
a step (b) in which the system management section allocates and releases resources according to the resource assignment changed by the congestion analysis section in the step (a).

8. The resource management method of claim 7, wherein the step (a) includes:
a step (a1) in which the congestion analysis section compares an amount of resource required for a function being requested to be added with an amount of resource available; and
a step (a2) in which if it is determined in the step (a1) that the amount of resource available is less than the amount of resource required for the function being requested to be added, the congestion analysis section makes an inquiry as to deletion of an active function among the extended functions.

9. The resource management method of claim 7, wherein:
there are a plurality of media modules;
the module information includes a media module priority; and
the media processor further includes a module determination section, the step (a) including:
a step (a1) in which the congestion analysis section compares an amount of resource required for a function being requested to be added with an amount of resource available;
a step (a3) in which if it is determined in the step (a1) that the amount of resource available is less than the amount of resource required for the function being requested to be added, the module determination section preferentially selects a media module having a lower media module priority as a media module whose function is to be deleted; and
a step (a4) in which the congestion analysis section makes an inquiry as to deletion of an active function of the media module selected in the step (a3).

10. The resource management method of claim 7, wherein:
the module information includes a function priority for the extended function; and
the media processor further includes a function determination section, the step (a) including:
a step (a1) in which the congestion analysis section compares the amount of resource required for a function being requested to be added with an amount of resource available;
a step (a5) in which if it is determined in the step (a1) that the amount of resource available is less than the amount of resource required for the function being requested to be added, the function determination section preferentially selects an active extended function having a lower function priority as an extended function to be deleted; and
a step (a6) in which the congestion analysis section makes an inquiry as to deletion of the extended function selected in the step (a5).

11. The resource management method of claim 7, wherein the media processor further includes a response processing section, the step (a) including:
a step (a1) in which the congestion analysis section compares an amount of resource required for a function being requested to be added with an amount of resource available;
a step (a7) in which if it is determined in the step (a1) that the amount of resource available is less than the amount of resource required for the function being requested to be added, the congestion analysis section inquires the media module as to deletion of a plurality of active extended functions;
a step (a8) in which the response processing section decides to delete at least the extended function of the media module that has returned a response first after the step (a7); and
a step (a9) in which the response processing section sends a cancellation response to a media module responding after the step (a8).

12. A computer-readable recording medium storing a program for instructing a computer to execute:
a step (a) of, if it is determined that a resource congestion will occur as a result of a function addition request being issued, changing a resource assignment by referencing module information and module status information, the module information including function information for the media module and resource information for the media processing function, and the module status information indicating whether or not the media processing function is being active; and
a step (b) of allocating and releasing resources according to the resource assignment changed in the step (a).
